(19) United States
(12) Patent Application Publication
(10) Pub. No.: US 2023/0385601 A1
(43) Pub. Date: Nov. 30, 2023

(54) Data Pruning Tool and Related Aspects

(71) Applicant: Telefonaktiebolaget LM Ericsson (publ), Stockholm (SE)

(72) Inventors: Prashant Sharma, Malmö (SE); Leonard Rexberg, Hässelby (SE)

(21) Appl. No.: 18/031,406

(22) PCT Filed: Oct. 12, 2020
(86) PCT No.: PCT/EP2020/078661

§ 371 Date: Apr. 12, 2023

(51) Int. Cl. G06N 3/04; G06F 11/36; G06N 3/088

(52) U.S. Cl. CPC G06N 3/04; G06F 11/3696; G06N 3/088

(57) ABSTRACT

A method and related aspects are disclosed for determining one or more regions of interest in a multi-dimensional data set comprising a plurality of parameter sets, each parameter set comprising a parameter set identifier, a plurality of dimensions of selection conditions for assessing a configurable physical entity, and an indication of an assessed characteristic of the configurable physical entity. The method comprises at least mapping, using a self-organising map, SOM, model which uses competitive group learning, the multi-dimensional data set onto an edge-connected surface mesh of neurons; identifying at least one cluster of neurons on the surface mesh based on a category of the assessed characteristic; identifying a set of ranges of boundary values for the selection conditions for each cluster, each range of boundary values comprising a maximum and a minimum weight value of the weights representing that selection condition of the neurons in that cluster; and determining one or more regions of interest which associate the boundary values of the selection conditions of each cluster with one or more test case identifiers for the test cases represented by the neurons in that cluster. The method may be implemented in some embodiments as a data pruning tool.

### TECHNICAL FIELD

The present disclosure relates to a data pruning tool including a group-learning self-organized map, SOM, machine learning, ML, model, and to related aspects where the SOM may be used iteratively to identify and drill down into one or more regions of interest in a large multi-dimensional data set.

In particular, but not exclusively, in some embodiments, the multi-dimensional data set comprises a set of test cases representing N dimensions of test conditions over which a test was performed on a particular configuration of a configurable physical entity. An example of a physical entity which can be tested over multiple dimensions of test conditions comprises a transceiver with a configurable digital pre-distortion, DPD, unit. A signal output by the transceiver can be tested over various ranges of radio settings using a transceiver test for the peak power spectrum of the output signal. The transceiver test determines if a particular DPD configuration of the transceiver results in the transceiver outputting a signal having a peak power spectrum which exceeds a peak power spectrum mask, and so failing the transceiver power output test, or if the signal output has a peak power spectrum which is below a peak power spectrum mask, in which case the transceiver passes the transceiver power output test.

In particular, but not exclusively, the data pruning tool reduces the range of radio settings over which different configurations of the transceiver need to be tested using a self-organizing map, SOM, machine learning, ML, model. The SOM ML model finds regions of interest comprising ranges of each of the N dimensional test conditions (i.e. of the N different radio settings) within which the transceiver did not pass the transceiver test. Tests can then be repeated using a new configuration of the transceiver just for those ranges of test conditions which results in fewer tests being performed. The test condition ranges over which different configurations need to be retested can be narrowed down further by repeatedly using the data pruning tool as the SOM ML model uses a competitive group learning SOM process. This enables test-cases to be repeated for different DPD configurations of the transceiver until a configuration set has been found which can be used to configure the transceiver to pass the transceiver test over various ranges of test criteria.

Some examples of the disclosed data pruning tool and SOM ML model can be used for finding configuration sets for other types of configurable physical entities, such as, for example, another type of device or substance. In some examples, the multi-dimensional data set comprises a plurality of parameter sets, each parameter set comprising a N-dimensional set of N test or selection conditions over which a particular configuration of the configurable physical entity is assessed or tested.

### BACKGROUND

Testing or assessing a physical entity which can adopt a variety of different configurations, some of which may pass a test, some of which may not, can introduce great complexity into a test process. A given configuration or state of the physical entity may pass certain ranges of test or selection conditions, but not others. A new configuration of the physical entity may pass the test for some or all or just a sub-range of one of the ranges of test or selection conditions where a previous configuration failed the same test, but may then fail in regions where it passed the test previously. If the aim is to find configurations of the physical entity which result in the physical entity passing a test for all tested ranges of test or selection conditions, this can be very time-consuming. The amount of time and resources used, particularly if the number of test or selection conditions over which the test is to be conducted is high, or if any one of the test conditions can take a wide range of possible values or states over which the test needs to be repeated, can escalate to impractical levels.

As an example, transceiver devices in communications systems amplify an input signal to boost its output for retransmission into free space. Such devices can use digital pre-distortion, DPD, to adjust the power amplifier of the transceiver to linearize the amplification of the output signal over a range of frequencies. Some transceivers can be configured with radio settings which enable the transceiver to output a signal for transmission over a variety of different types and numbers of carrier networks (for example, a number of different long term evolution, LTE carrier networks as well as a number of GSM carrier networks). However, a single configuration of the DPD of the transceiver does not work over the full range of radio settings.

A SOM algorithm is an unsupervised competitive learning neural network type of algorithm which implements a particular linear projection from a high dimensional input data space into a lower dimensional arrangement of neurons. A SOM model can be used to classify data, for example, by discovering and generating a representation of particular areas of an input space in the form of clusters of neurons on the SOM mesh. The clusters result from the way that each individual neuron of the SOM model competes to have its weights adapted to conform with a selected input vector of the input data and influences its neighborhood.

In a conventional SOM ML model, each neuron competes individually to be mapped to an input vector based on its closeness to an input vector in a traditional SOM model. The winning neuron is the neuron whose weight vectors are closest to the corresponding weights of a selected input vector. The winning neurons' weights are then updated to match those of the input vector. A similar weight adaptation is then performed on the weights of a number of neighboring neurons using a neighborhood function. The process of selecting input vectors from the input space is repeated until the entire input space has been mapped to neurons on the SOM mesh. In this manner the SOM model is trained using the input space to present the input space as an ordered structure on the SOM mesh.

A conventional SOM model mapping is affected by the random order of the input vector selection. This makes conventional SOM models unsuitable for exploring very large data sets iteratively, as they cannot be relied upon to consistently map the large data sets into the same map structures each time the SOM is regenerated.

In addition, the higher the dimensionality of the input vector, the more challenging it is for a SOM ML model to form clusters in a low dimensional space and the larger the likelihood of errors.

### SUMMARY

The preferred aspects and embodiments of the disclosed technology are set out in the accompanying claims and following clauses.

The disclosed embodiments use a data pruning tool comprising a SOM ML model which can be iteratively used to implement a method of finding one or more regions of interest, ROI, within multi-dimensional data set of test-cases or parameter sets. Each test-case or parameter set comprises at least a test-identifier (or a parameter identifier) and a set of multiple different test or selection parameter values, and a test result or category indicator, or some other type of assessed characteristic of a configurable physical entity. Each test or selection parameter value represents a value or state of a test or selection condition which existed when a particular configuration of a configurable physical entity, such as a transceiver device was being tested.

By performing the method of finding one or more regions of interest, ROI, the ranges of each test (or selection) parameter value for a test (or selection) condition present when the test was conducted (or some other type of assessment of a characteristic of the configurable physical entity was conduction), and failed by a particular configuration of the physical entity are determined. A new configuration of the physical entity can then be retested (or reassessed) and the range of each of the N test (or selection) conditions for the re-test/re-assessment limited to just the ranges associated with each of the one or more regions of interest. In this manner, a set of configurations of the physical entity can be found which the physical entity can adopt to pass the test/assessment over the original ranges of N test or selection conditions.

One aspect of the disclosed technology relates to a method for determining one or more regions of interest in a multi-dimensional data set comprising a plurality of parameter sets, each parameter set comprising a parameter set identifier, a plurality of dimensions of selection conditions for assessing a configurable physical entity, and an indication of an assessed characteristic of the configurable physical entity, the method comprising: mapping, using a SOM model which uses competitive group learning, the multi-dimensional data set onto an edge-connected surface mesh of neurons; identifying at least one cluster of neurons on the surface mesh based on a category of the assessed characteristic; identifying a set of ranges of boundary values for the selection conditions for each cluster, each range of boundary values comprising a maximum and a minimum weight value of the weights representing that selection condition of the neurons in that cluster; and determining one or more regions of interest which associate the boundary values of the selection conditions of each cluster with one or more test case identifiers for the test cases represented by the neurons in that cluster.

In some embodiments, the number of different ranges comprising boundary values for each of the selection conditions is less than the total number of selection conditions. This may be implemented, for example, to reduce the number of selection conditions used for the cluster analysis.

In some embodiments, using the SOM model comprises: generating a representation of the parameter sets of the multi-dimensional data set on an edge-connected SOM surface mesh comprising a plurality of neurons, each individual parameter set being allocated to a selected neuron, wherein using the self-organizing maps model comprises determining a center neuron of a collection of adjacent neurons as the selected neuron for an individual parameter set when a collective correlation of the individual parameter set with the collection of adjacent neurons has a value that is greater than any collective correlation of the individual parameter set with all other possible collections of adjacent neurons.

In some embodiments, the method further comprises transforming the edge-connected surface mesh to a two-dimensional planar surface mesh prior to generating the regions of interest. For example, a toroidal or hypertoroidal mesh can be transformed into an edged planar surface mesh to reduce the computational complexity associated with using a continuous surface mesh. The transformation can take place at any point where it is advantageous to reduce the computational complexity.

In some embodiments, the method further comprises resizing at least one cluster to have a size matching or exceeding a predefined ratio of one category of the assessed characteristic to another category of the assessed characteristic

In some embodiments, the method further comprises resizing at least one cluster to minimize the number of overlapping dimensions of selection conditions of that cluster with at least one other cluster on the SOM surface mesh.

In some embodiments, the method further comprises: reconfiguring the physical entity and repeating the assessment using the selection conditions of each parameter set associated with a region of interest; updating each parameter set associated with a region of interest in the multi-dimensional data set with at least the result of the repeated assessment; and iteratively repeating the first method aspect using an embodiment with the same SOM model to find if there are any new regions of interest in the updated data set.

In some embodiments, the method further comprises: one or more of the steps of reconfiguring the physical entity and updating each parameter set is controlled or performed manually.

In some embodiments, the method comprises a computer-implemented method.

In some embodiments, the parameter sets comprise a test-case, the plurality of dimensions of selection conditions comprise dimensions of test conditions, and the indication of the assessed characteristic comprises a test result of a test performed on the configurable physical entity under the test conditions.

In some embodiments, the configurable physical entity comprises a transceiver including a configurable DPD unit, the test conditions comprise radio settings for testing the transceiver, and the test comprises a transceiver test performed on the output signal of the transceiver.

In some embodiments, the assessed characteristic comprises a fail test result category if the peak output power of the output signal of the transceiver exceeds a regulatory standard body spectrum mask for peak output power for one or more carrier networks.

In some embodiments, the radio settings for testing the transceiver comprise the number or LTE carrier networks, the number of GSM carrier networks, the instantaneous bandwidth and the occupied bandwidth for the signal output by the transceiver.

In some embodiments, the configurable physical entity is one of: a configurable substance, such as, for example, a glass or concrete or other material or substance; a configurable device; or a device including a configurable component. Some other examples of configurable substances include food substances, medicinal substances, and liquid and gas substances, which can be configured with different relative proportions of the same constituent materials or chemical.

A second aspect of the disclosed technology comprises a method for determining one or more regions of interest in a multi-dimensional data set comprising a plurality of transceiver test cases, each transceiver test case comprising a test case identifier, plurality of radio settings for testing a configurable transceiver, and an indication of a test result of the transceiver test case for that plurality of radio settings, the method comprising: mapping, using a SOM model which uses competitive group learning, the multi-dimensional data set of test cases onto an edge-connected toroidal surface mesh of neurons; identifying at least one cluster of neurons on the surface mesh based on the test result category of transceiver test; determining a set of ranges comprising boundary values for each radio setting for each cluster, each range of boundary values comprising a maximum and a minimum weight value of the weights representing that radio setting of the neurons in that cluster; and determining one or more regions of interest which associate each of the sets of radio setting boundary values of each cluster with one or more test case identifiers for the test cases represented by the neurons in that cluster which failed the transceiver test.

In some embodiments, the method comprises a computer-implemented method.

In some embodiments, the number of different ranges comprising boundary values for each of the test conditions is less than the total number of test conditions. This may be implemented, for example, to reduce the number of test conditions used for the cluster analysis.

In some embodiments, using the SOM model comprises: generating an representation of the test cases of the multi-dimensional data set on an edge-connected SOM surface mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons.

In some embodiments, the method further comprises transforming the edge-connected surface mesh to a two-dimensional planar edged surface mesh prior to the step of identifying at least one cluster.

In some embodiments, the indication of a test result of the transceiver test comprises a test fail if the peak output power of the output signal of the transceiver exceeds a regulatory standard body spectrum mask for peak output power for one or more carrier networks.

In some embodiments, the method further comprises resizing at least one cluster to have a size matching or exceeding a predefined ratio of test fails to test passes.

In some embodiments, the method further comprises resizing at least one cluster to minimize the number of overlapping dimensions of radio settings of that cluster with at least one other cluster.

In some embodiments, the method further comprises: reconfiguring the transceiver and repeating the test using the radio settings of each test case associated with a region of interest; updating each test case associated with a region of interest in the multi-dimensional data set with at least the result of the repeated test; and iteratively repeating the steps of any embodiment of the second aspect using the same SOM model to find if there are any new regions of interest in the updated data set.

In some embodiments, the reconfiguring and/or the updating may be performed manually.

A third aspect of the disclosed technology comprises a method for determining regions of interest in a multi-dimensional input space, wherein the multi-dimensional input space represents a plurality of test cases for use with each of one or more radio settings of a transceiver device, the method comprising the following steps: analyzing the plurality of test cases using a self-organizing maps model to provide a representation of the test cases on a toroidal mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons; converting the toroidal mesh representation into a two-dimensional representation, associating test results for each of the plurality of test cases with the respective neuron, identifying one or more clusters of neurons within the two-dimensional representation based on the test results, and associating one or more regions of interest in the multi-dimensional input space with the one or more identified clusters of neurons within the two-dimensional representation.

In some embodiments of the third aspect, the method is a computer-implemented method.

In some embodiments, the radio settings are used to test the transceiver over a range of one or more of different frequency ranges, modulation types, and bandwidths.

A fourth aspect of the disclosed technology comprises a method of testing a transceiver having configurable digital pre-distortion DPD, the test comprising: determining one or more regions of interest in a multi-dimensional data set of test cases using a group learning SOM model to determine at least one region of interest comprising a set of boundary values of a plurality of radio settings for testing the transceiver where a first configuration of the DPD results in the transceiver failing a transceiver peak power spectrum output test; reconfiguring the DPD with a different set of linearization parameters; retesting the transceiver with the reconfigured DPD using radio settings of each test-case in the at least one region of interest; updating the multi-dimensional data set of test cases with at least a new test result for each retested test case; and and repeating the method of the first step using the same SOM model configuration to determine if there are one or more regions where the new configuration of the DPD results in the transceiver failing the transceiver peak power spectrum output.

In some embodiments, the SOM model provides a representation of the test cases on a toroidal mesh comprising a plurality of neurons, each individual test case being allocated to a selected neuron, wherein the SOM model determines a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons.

In some embodiments, the radio settings used to test the transceiver over a range of one or more of different frequency ranges, modulation types, and bandwidths.

In some embodiments, the method of the fourth aspect is a computer-implemented method.

In some embodiments, the configuration of the DPD using different linearization parameters is automated using a computerized test-set up for performing an embodiment of the fourth aspect.

A fifth aspect of the disclosed technology comprises apparatus comprising means configured to perform the steps of an embodiment of any one of the first to fourth method aspects.

In some embodiments of the fifth aspect, the apparatus comprising means configured to perform the steps of an embodiment of any one of the first to fourth method aspects comprises a memory, at least one processor, and computer code stored in the memory which, when executed by the at least one processor, causes or configures the apparatus to perform the steps of an embodiment of any one of the first to fourth method aspects.

In some embodiments, the computer code is configured as a plurality of modules.

A sixth aspect of the disclosed technology comprises apparatus comprising memory, at least one processor, and computer code stored in the memory which, when executed by the at least one processor, causes the apparatus to perform the steps of an embodiment of any one of the first to fourth method aspects.

A seventh aspect of the disclosed technology comprises a machine executable computer-program product, comprising computer code which, when executed on an embodiment of an apparatus according to the fifth or sixth aspect causes the apparatus to perform the steps of an embodiment of any one of the first to fourth method aspects.

The apparatus implementing any of the disclosed embodiments of a method aspect comprises in some embodiments a data pruning tool according to any of the disclosed embodiments.

An eighth aspect of the disclosed technology comprises an apparatus or processing circuitry configured to determine one or more regions of interest in a multi-dimensional data set comprising a plurality of parameter sets, each parameter set comprising a parameter set identifier, a plurality of dimensions of selection conditions for assessing a configurable physical entity, and an indication of an assessed characteristic of the configurable physical entity.

In some embodiments, the apparatus or processing circuitry is configured to or comprises: a mapping module for mapping, using a SOM model which uses competitive group learning, the multi-dimensional data set onto an edge-connected surface mesh of neurons; an identifying module for identifying at least one cluster of neurons on the surface mesh based on a category of the assessed characteristic; another identifying or determining module for identifying or determining a set of ranges of boundary values for the selection conditions for each cluster, each range of boundary values comprising a maximum and a minimum weight value of the weights representing that selection condition of the neurons in that cluster; and a module for determining one or more regions of interest which associate the boundary values of the selection conditions of each cluster with one or more test case identifiers for the test cases represented by the neurons in that cluster.

An ninth aspect of the disclosed technology comprises an apparatus or processing circuitry configured to determine one or more regions of interest in a multi-dimensional data set comprising a plurality of transceiver test cases, each transceiver test case comprising a test case identifier, plurality of radio settings for testing a configurable transceiver, and an indication of a test result of the transceiver test case for that plurality of radio settings.

In some embodiments, the apparatus or processing circuitry is configured to or comprises: a mapping module configured to map, using a SOM model which uses competitive group learning, the multi-dimensional data set of test cases onto an edge-connected toroidal surface mesh of neurons; an identifying or determining module configured to identify or determine at least one cluster of neurons on the surface mesh based on the test result category of transceiver test; an identifying or determining module configured to identify or determine a set of ranges comprising boundary values for each radio setting for each cluster, each range of boundary values comprising a maximum and a minimum weight value of the weights representing that radio setting of the neurons in that cluster; and an identifying or determining module configured to identify or determine one or more regions of interest which associate each of the sets of radio setting boundary values of each cluster with one or more test case identifiers for the test cases represented by the neurons in that cluster which failed the transceiver test.

A tenth aspect of the disclosed technology comprises an apparatus or processing circuitry configured to determine regions of interest in a multi-dimensional input space, wherein the multi-dimensional input space represents a plurality of test cases for use with each of one or more radio settings of a transceiver device. For example, apparatus or processing circuitry configured to perform any one of the first, second, third or fourth method aspects. In some embodiments, the apparatus or processing circuitry is configured to or comprises a data pruning tool.

In some embodiments, the apparatus or processing circuitry method is configured to or comprises one or modules configured to perform: analyzing the plurality of test cases using a self-organizing maps model to provide a representation of the test cases on a toroidal mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons; converting the toroidal mesh representation into a two-dimensional representation, associating test results for each of the plurality of test cases with the respective neuron, identifying one or more clusters of neurons within the two-dimensional representation based on the test results, and associating one or more regions of interest in the multi-dimensional input space with the one or more identified clusters of neurons within the two-dimensional representation.

An eleventh aspect of the invention comprises an apparatus or processing circuitry configured to test a transceiver having configurable digital pre-distortion DPD. In some embodiments, the apparatus or processing circuitry is configured to or comprises: a determining module configured to determine one or more regions of interest in a multi-dimensional data set of test cases using a group learning SOM model to determine at least one region of interest comprising a set of boundary values of a plurality of radio settings for testing the transceiver where a first configuration of the DPD results in the transceiver failing a transceiver peak power spectrum output test; a reconfiguring module configured to reconfigure the DPD with a different set of linearization parameters; a (re)testing module configured to (re)test the transceiver with the reconfigured DPD using radio settings of each test-case in the at least one region of interest; and an updating module configured to update the multi-dimensional data set of test cases with at least a new test result for each retested test case. In some embodiments of the apparatus and/or processing circuity, the same SOM model configuration in the determining module is used repeatedly to determine if there are one or more regions of interest where the new configuration of the DPD results in the transceiver failing the transceiver peak power spectrum output test.

Another aspect of the disclosed technology comprises a computer program, comprising instructions which, when executed in a processing circuitry, cause the processing circuitry to carry out any of the above method aspects. In some embodiments, the computer program comprises the computer code of any of the embodiments of the fifth, sixth, or seventh aspects including computer code.

Another aspect of the disclosed technology comprises a carrier containing the computer program aspect, wherein the carrier is one of an electronic signal, optical signal, radio signal, or computer-readable storage medium.

Another aspect of the disclosed technology comprises a data pruning tool comprising the computer program aspect and processing circuitry for executing the computer program aspect.

The aspects and embodiments of the disclosed technology seek to solve, obviate, mitigate, alleviate or eliminate the problems with known approaches for reducing the complexity of testing or otherwise assessing a configurable physical entity over a set of ranges, each range comprising maximum and minimum values of a plurality of test conditions.

### BRIEF DESCRIPTION OF THE DRAWINGS

Further objects, features and advantages will appear from the following detailed description of embodiments, which are by way of example only, and with reference being made to the accompanying drawings. The drawings are not necessarily to scale, emphasis instead being placed upon schematically illustrating the example embodiments.

FIG. 1 illustrates schematically a test set-up for transceiver which uses a data pruning tool according to some embodiments;

FIG. 2A illustrates schematically a test-system for a configurable physical entity which uses a data pruning tool including a group-learning SOM ML model according to a embodiment;

FIG. 2B illustrates schematically a test—system for a configurable device which uses a data pruning tool including a group-learning SOM ML model according to another embodiment;

FIG. 2C illustrates schematically a test—system for a particular substance which uses a data pruning tool including a group-learning SOM ML model according to another embodiment;

FIG. 3 illustrates schematically more details of a data pruning tool for determining regions of interest in a set of test cases according to another embodiment;

FIG. 4 illustrates schematically steps in a method of testing a configurable physical entity using the data pruning tool of FIG. 3;

FIG. 5 illustrates schematically more details of the initial configuration step of FIG. 4;

FIG. 6 illustrates schematically more details of the SOM mapping step of FIG. 4;

FIG. 7 illustrates schematically more details of the determining a best matching group step of FIG. 6;

FIG. 8A illustrates schematically an example of an input vector selection and mapping process to a winning neuron on an edge-connected mesh of a SOM model according to some embodiments;

FIG. 8B illustrates schematically an example of an edged surface mesh formed from the example edge-connected surface mesh of FIG. 5 according to some embodiments;

FIG. 8C illustrates schematically how the SOM model maps an input training data set to form a structure on edge connected surface according to some embodiments;

FIG. 8D illustrates schematically a version of the edge-connected map structure of FIG. 8C transformed to a structure on an edged surface mesh of the SOM model according to some embodiments;

FIG. 8E illustrates schematically pass/fail test results for a transceiver test used by some of the embodiments;

FIGS. 9A and 9B illustrate schematically two different examples of a group of nine adjacent neurons on an example edge-connected surface mesh of a SOM model according to some embodiments;

FIG. 9C illustrates schematically an example of a winning group comprising four adjacent neurons on an example edge-connected surface mesh of a SOM model according to some of the embodiments;

FIG. 9D illustrates schematically the creation of a central neuron in the example of FIG. 9C according to some embodiments;

FIG. 10 illustrates schematically mapping transform process steps performed by the 2D module 800 of a data pruning tool according to some embodiments.

FIG. 11 illustrates schematically the effect of the process steps of FIG. 10 according to some embodiments;

FIG. 12 illustrates schematically cluster identification process steps performed the SCA module 900 of a data pruning tool according to some embodiments.

FIG. 13 illustrates schematically the effect of process steps of FIG. 12 according to some embodiments;

FIG. 14 illustrates schematically range set process steps performed by an example of a define boundaries module 1000 of a data pruning tool according to some embodiments.

FIG. 15 illustrates schematically the effect of the process steps of FIG. 14 according to some embodiments;

FIG. 16A illustrates schematically process steps performed by an example of an optimize define section boundaries module 1100 of a data pruning tool according to some embodiments.

FIG. 16B illustrates schematically in more detail step of the overlap analysis performed in the process steps of FIG. 16A according to some embodiments;

FIGS. 16C and 16D illustrate schematically the effect of the process steps of FIG. 16A and 16B according to some embodiments;

FIGS. 16E and 16F illustrate schematically how the output of SCA module 900 is affected by optimization by the optimize section boundaries module 1100 according to some embodiments;

FIG. 17A illustrates schematically how regions of interest are determined and test-case identifiers determined for each region of interest found according to some disclose embodiments;

FIG. 17B illustrates schematically how the ranges of test conditions for which new configurations of the physical entity are required to pass a test are found according to some embodiments;

FIG. 18A to 18D illustrate schematically an example representation of how the data pruning tool can determine a set of configurations for a physical entity to take in a set of sub-ranges of one dimension of test conditions to result in a test pass according to some embodiments; and

FIG. 19 illustrates schematically a computer apparatus on which a data pruning tool may be implemented according to some embodiments;

### DETAILED DESCRIPTION

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise. Generally, when an arrangement is referred to herein, it is to be understood as a physical product; e.g., an apparatus. The physical product may comprise one or more parts, such as controlling circuitry in the form of one or more controllers, one or more processors, or the like.

Embodiments of the present disclosure will be described and exemplified more fully hereinafter with reference to the accompanying drawings. The solutions disclosed herein can, however, be realized in many different forms and should not be construed as being limited to the embodiments set forth herein.

The features of the above disclosed aspects and embodiments may not be explicitly disclosed in a particular combination in the following description for the sake of brevity but, nonetheless, where a suitable combination would be apparent to anyone of ordinary skill in the art without undue effort the description should be construed to include such a combination of features.

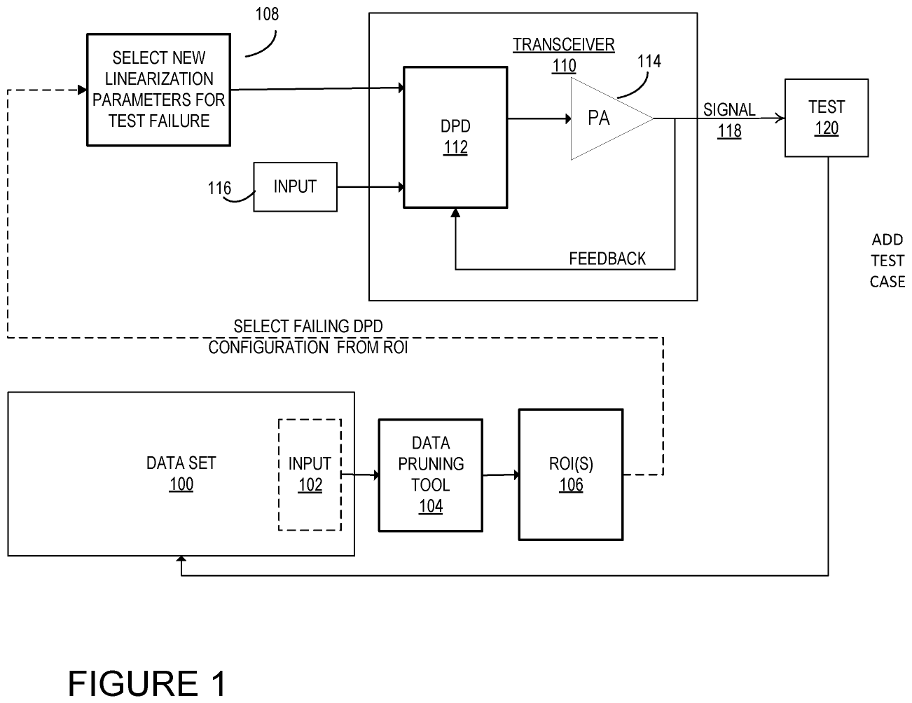

FIG. 1 illustrates schematically an example embodiment of a test set-up for transceiver 110 which uses an example embodiment of a data pruning tool, DPT, 104 to implement a method of finding regions of interest in a large multi-dimensional data set comprising ranges of radio settings over which transceiver 110 failed a transceiver test.

In FIG. 1, the transceiver 110 comprises a digital pre-distortion, DPD, component or unit 112 and a power amplifier, PA, 114. The example of the transceiver 110 in FIG. 1 includes a feedback loop from the output of the PA 114 back to the DPD 112. The transceiver test is performed using a test step up 120 on the output signal 118 of the transceiver 110. In the example embodiment shown in FIG. 1, the transceiver test determines if a particular configuration of DPD 112 provided an amplification of input signal 116 which resulted in output signal 118 having a peak power spectrum exceeding or remaining below a communications standard's regulatory mask for the ranges of tested radio settings. If the output signal's peak power spectrum exceeds the regulatory mask value, the test is failed. The peak power spectrum comprises, in some embodiments, excess spectrum, for example, spectrum outside the intended frequency range.

Also shown in FIG. 1 is a multi-dimensional data set 100 comprising a plurality of multi-dimensional test cases. Each test case represents a test conducted under certain test conditions on a particular configuration of the transceiver. Each test-case record 102 in the data set 100 comprises at least a test-case identifier, referred to here a Test-Case ID; a set of N values for the N different test or selection conditions under which the test was conducted, and a test result category. Each of N different test or selection conditions may be represented by a test parameter value or a test parameter and value pair in a test-case.

Examples of test parameter values for an example embodiment of the transceiver test comprise a parameter value for each of the radio settings used to test the transceiver, for example, the type of network, the bandwidth, the modulation. Some examples of radio settings for the test configuration include an instantaneous bandwidth (IBW) value, an occupied bandwidth value (OBW), a number n of GSM carrier networks (nGSM), an a number n of LTE carrier networks (nLTE).

In some embodiments, a test case for the transceiver test conditions comprises a test identifier, and four parameter values, each value representing one of an IBW value, an OBW value, the n GSM carrier networks and n LTE networks, and a pass/fail indication for the test result category.

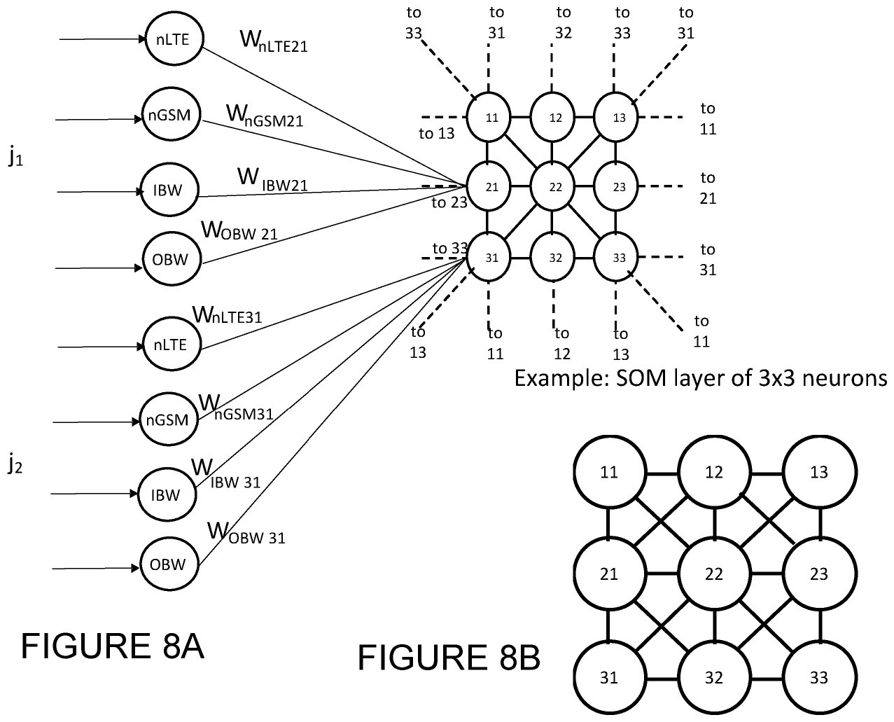

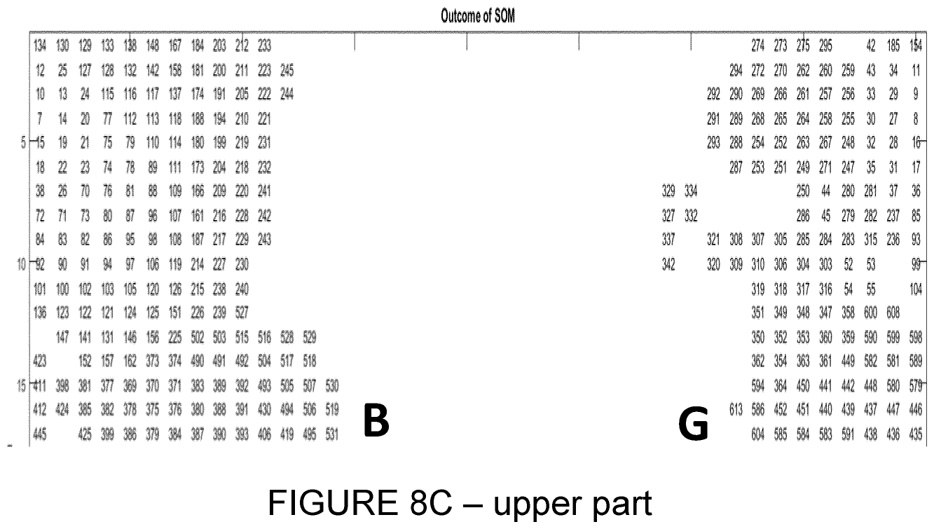

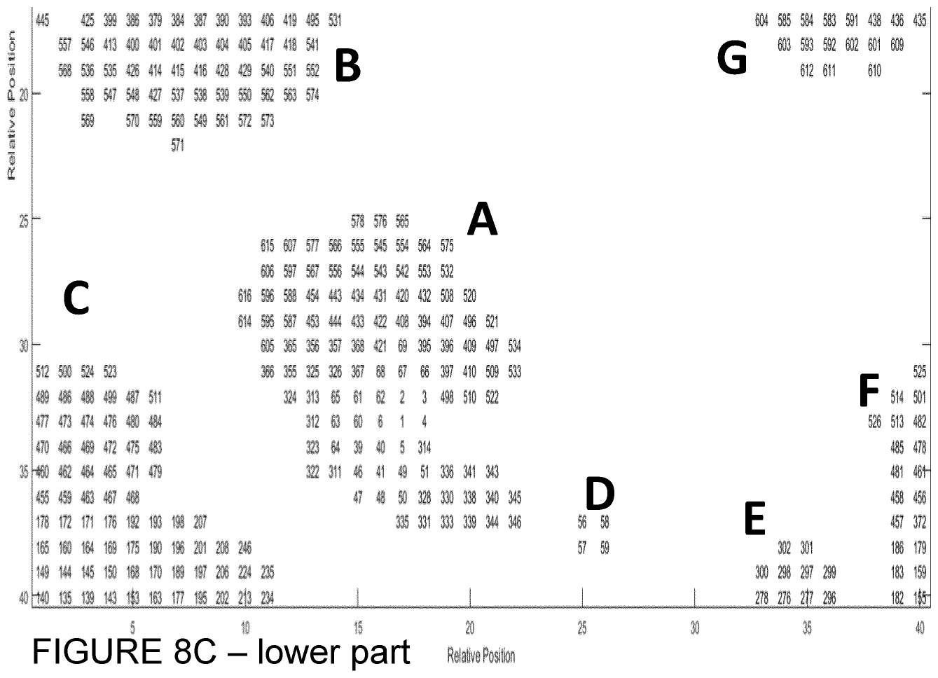

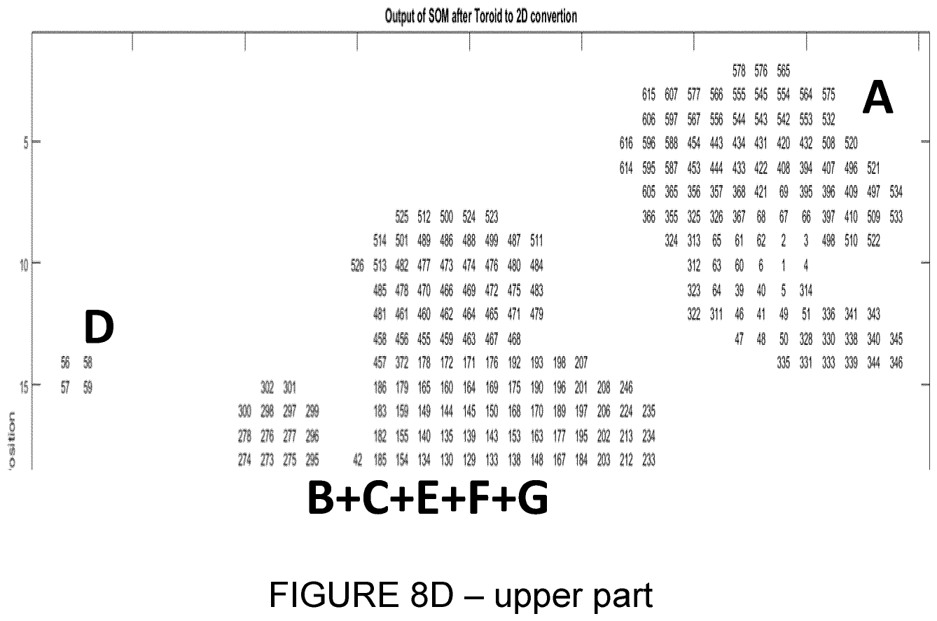

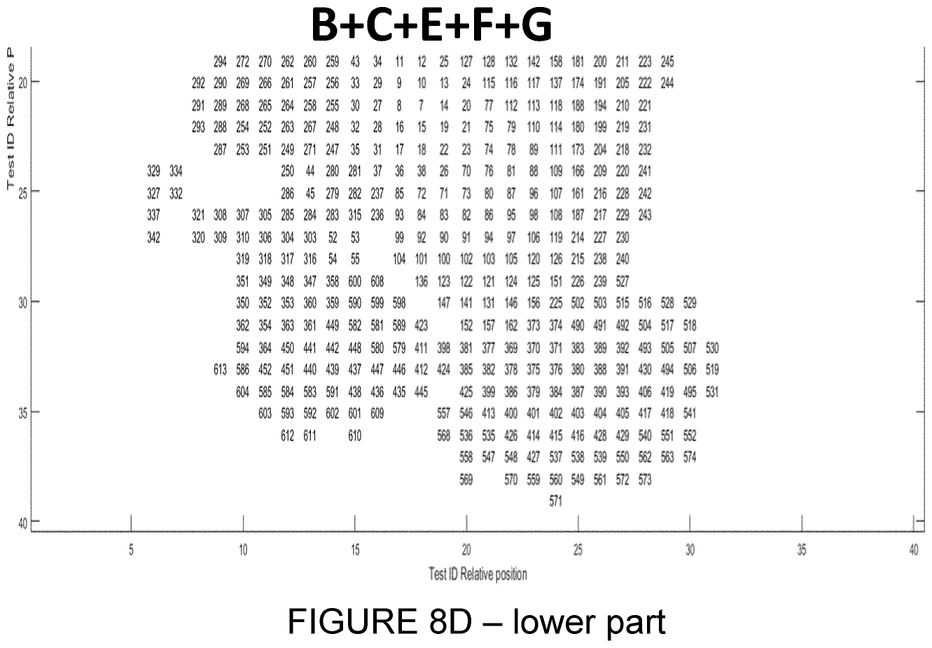

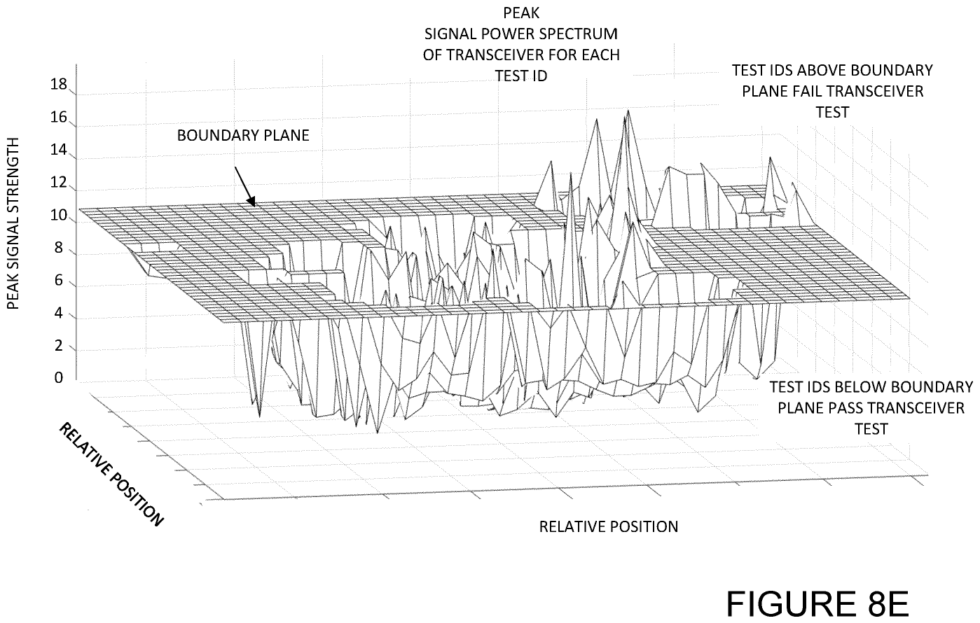

In some embodiments, a test result indication may be an indication of a test result category, such as a pass or fail of a particular test, or a test result value. FIG. 8E, described in more detail below, illustrates the test results.

In the example test set-up shown schematically in FIG. 1, test case data 102 from the multi-dimensional data set 100 is input one test-case at a time into a SOM ML model module 700 (not shown in FIG. 1) of the DPT 104. The SOM ML model is configured to use competitive group learning to map each test-case onto a surface mesh of the SOM. Other components of the DPT 104 then find regions of interest 104 by determining one or more unique groups or clusters of neurons. Each cluster can be associated with a set of N ranges, each range representing a maximum and minimum value of a particular test parameter value for a test condition, or radio setting, for the transceiver test.

Each ROI 105 which is found using the DPT 104 comprises a set of ranges of test case parameter values for the test conditions within which the test cases are associated with test failures, i.e. each ROI indicates a range for each of the N radio settings of the transceiver within which the output signal 118 of the transceiver 110 failed the transceiver test.

A tester or user of the test set-up (which may be a human or a machine or robot) is then able to re-test a new DPD configuration for the transceiver only over the range set associated with that ROI. In other words, it is only necessary to repeat the test for those test-cases using a new DPD configuration over the radio setting ranges associated with each ROI the DPT 104 finds.

A re-test may be performed by selecting a test-case from a ROI and assigning a new set of linearization parameters to reconfigure the DPD of the transceiver 110. The same transceiver test is then repeated over the radio settings of the ROI (which correspond to where the previous DPD configuration resulted in the transceiver failing the test).

The new test case and its test result can then be added to the data-set 100 of test-cases and the process repeated by inputting the updated data-set 100 to find if there are any regions of interest where the transceiver with new DPD configuration also failed to pass the transceiver test.

The retest process can be reiterated using the DPT 104 until a set of DPD configurations has been found which can be used to configure the transceiver for various range of radio settings. This enables the output signal 118 of the transceiver to always pass the transceiver test over the full tested range of radio settings providing the transceiver is configured correctly.

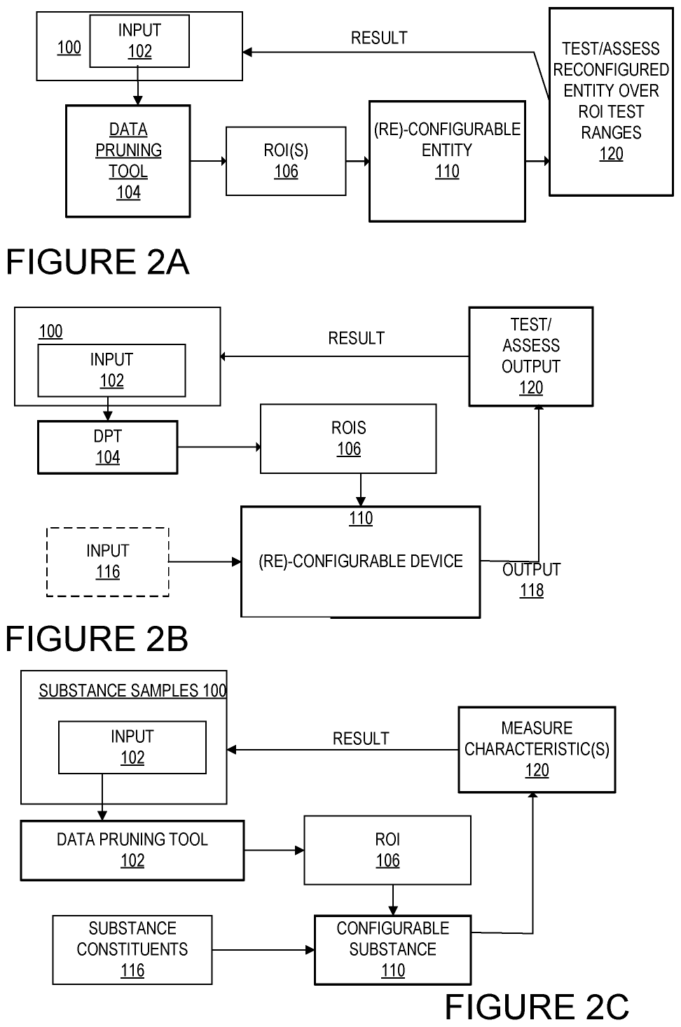

FIG. 2A illustrates how the DPT 104 of FIG. 1 can be used in a general embodiment of a test-set up to implement a method of determining one or more ROIs 106 in a multi-dimensional data set 100 of test cases for another type of configurable physical entity 110. FIGS. 2B illustrates schematically an embodiment of the general test set-up where the configurable physical entity 110 comprises a configurable device 110 (for example, a configurable transceiver device such as FIG. 1 shows). FIG. 2C illustrates schematically an example of the configurable physical entity comprising a substance or material where the constituents or composition of the substance can take on a range of different values.

In some embodiments of a test-set up such as FIG. 2A shows, the configurable physical entity is a testable or assessable configurable or reconfigurable physical object or entity which has one or more physical attributes which can be configured or changed. An assessable configuration may be a measurable or detectable configuration in some embodiments

In some embodiments of a test-set up such as FIG. 2A shows, the configurable physical entity is a testable or assessable configurable or reconfigurable physical object or entity which includes one or more components which have one or more physical attributes which can be configured either by changing them or exchanging them. Example embodiments of the configurable physical entity include a configurable physical entity which is capable of being reconfigured to have a different physical state, or to have different attributes, or settings. Another example of a configurable physical entity is a substance such as FIG. 2C shows as substance 110, where the composition of the substance may be changed by adjusting the relative amounts of certain constituents and/or by substituting one or more chemical constituents for other chemical constituents which have similar physical or chemical characteristics. In some but not necessary all embodiments, reconfiguring a configurable physical entity provides a different configuration of the same physical entity. In some embodiments, however, a different configuration of another physical entity which is the same model or type of physical entity previously tested.

In some embodiments, the configurable physical entity comprises a configurable or re-configurable device, such as, FIG. 2B shows. In one example, the configurable physical entity comprises a transceiver device 110 with a configurable DPD 112.

In some embodiments, the configurable device is configured using a plurality of device settings to have (or in some embodiments, to cause to be manifested in the device or another device) a testable or measurable or otherwise assessable (for example, a detectable) physical condition, state, attribute, or other characteristic which is dependent on a configuration of the device settings. An example of a measurable characteristic which is affected by a test condition comprises a characteristic of a signal output by the device, such as a peak power spectrum of the signal output by the transceiver.

A test refers to a test or selection or measurement or other form of assessment of a measurable physical state and/or characteristic and/or attribute of the configurable physical entity conducted under at least one test condition. A test condition is a condition under which a test is conducted. In some embodiments, a test condition may comprise a selection or assessment constraint for the test. A test condition for testing a physical device can comprises an internal state or condition (e.g. a setting of the device) or an external condition or state, for example, an ambient or air temperature for that device to have when the test takes place. A test result may be provided as a metric, a probability or confidence score, a relative value or ratio, an absolute value, or as a category (e.g. a pass or fail of the test). A set of one or more test conditions accordingly define a test in a test case. In some embodiments, a test condition is an invariant or static condition for the duration of a test.

A test case comprises a data record a test of a configurable physical entity. A test case includes set of parameter values which represent a set of test conditions which defined the conditions under which the test was conducted. In some embodiments, the test case is associated with a test result metric and/or a test result category. Each test case is associated with a particular test set up which defines one or more test or measurement criteria which are assessed by the test and a set of one or more the rules for passing the test.

In the general embodiment of FIG. 2A, the DPT 104 generates a structured map of the multi-dimensional data set 100 of test cases 102 using a data pruning tool, DPT, 104 based on the test conditions under which each test case was conducted and the test result under those test conditions for a particular configuration of the re-configurable physical entity. The sets of parameter values, each set representing the test conditions of a test case 102, are mapped using a SOM ML model of DPT 104. The SOM ML model clusters the test cases (or parameter sets) according to their correlation with the features which represent test (or selection) parameters for the test (or selection conditions) over which a test (or an assessment) was conducted. Another component of the DPT 104 can then be used to find one or more regions of interest, ROls, 106 in the data set 100.

Each ROI 106 comprises one or more ranges for the test or selection conditions a cluster of test cases which meets certain cluster selection conditions, for example, which contain a certain number of test cases with a particular test result. Each range for at least one, or each (as in all) of the n-dimensions of test or selection conditions, in other words the maximum and minimum values for each test or selection parameter of a cluster of test cases or parameter sets which were found by the DPT to include a particular result category, for example, in the case of the transceiver, which were found to have failed the transceiver test. The tests (or assessments) associated with the test-IDs (or parameter set IDs) within each ROI are then repeated. Each test/assessment ID can be used to look-up a set of test/assessment/selection conditions under which the test was previously conducted. This allows the test (by which term is meant any suitable form of assessment of a measurable characteristic) to be repeated for those test/assessment conditions with a new configuration of the physical entity.

As only test/assessments which are within a set of ranges of test/assessment conditions associated with each ROI are extracted, far fewer tests need to be repeated than would be required if the test was repeated over the various possible combinations and ranges of test conditions using the new configuration of the physical entity.

Once a test has been repeated with the new configuration, a test result is created, and in some embodiments, a new test result category is determined. The new test cases data for each re-test is then added to the data set 100 by updating the test data for that test case using the test-case ID.

In some embodiments, although the test/selection conditions of the retest have not changed for that test-case, the test result metric and/or a test result category may have changed, for example, from a fail to a pass.

The process can be repeated until a set of configurations are found to configure the physical entity so it passes the test over the entire range of test conditions of the original data set 100.

In some embodiments, new test-cases are added to the data-set to interpolate within the values of the test conditions of existing test-cases within the boundary values of each ROI.

FIG. 2B shows how the configuration of the general example of the test set-up shown in FIG. 2A would be implemented if the reconfigurable physical entity is a configurable device, such as the transceiver of FIG. 1. In some examples of the embodiment illustrated In FIG. 2B, the multi-dimensional data set comprises a plurality of test cases or parameter sets, each including a test cases (or an assessment) identifier, a set of N parameter values, each value representing a different test or selection or assessment condition, and an indication of the result of the test or assessment for a particular configuration of the device. An example of a device that could be tested or assessed using the test set-up of FIG. 2B is an electric motor, which may be tested under a range of operational settings of the electric motor to see if the power output of the electric motor is, for example, sufficiently steady, or if the operating temperature of the electric motor remains below a threshold value. Operational settings for testing the electric motor include, for example, the rpm of the motor and the load on the motor.

FIG. 2C shows an example embodiment where the general example of the test set-up shown in FIG. 2A is used instead to assess (or test) a characteristic of a configurable substance in various different assessment conditions. In some examples of the embodiment illustrated In FIG. 2C, the multi-dimensional data set comprises a plurality of parameter sets, each including an assessment identifier, a set of N parameter values, each value representing a different selection or assessment condition, and an indication of the result of the assessment for a particular composition of the substance.

One example of such a substance comprises a glass having a particular chemical composition. In some embodiments, a various of compositions of the physical entity comprise various chemical compositions of the glass. In some embodiments, the test assesses if the glass will shatter under over various test conditions, for example, if the glass will shatter above a particular temperature, if the glass will shatter if used in a particular way, if the glass will shatter if made in a particular way. By testing the glass to see if it is suitable for a particular type of use and/or if it can be made using a particular manufacturing method, it is possible to determine categories of test results for particular compositions of glass to shatter/not shatter. If a glass shatters, this indicates it is not suitable for that particular type of use and/or not being suitable for being made a particular way, another composition of glass is picked and the test repeated. In some embodiments, glass test comprises a plurality of different selection conditions including one which provides an indication of whether a composition of glass substances is suitable for a certain use or has a physical property. For example, a glass may have a characteristic indicating it is suitable for use as a safety glass, or as high-impact glass, or as self-cleaning glass, or for use as a high-temperature cooking container etc. The associated glass properties can be measured by performing appropriate tests.

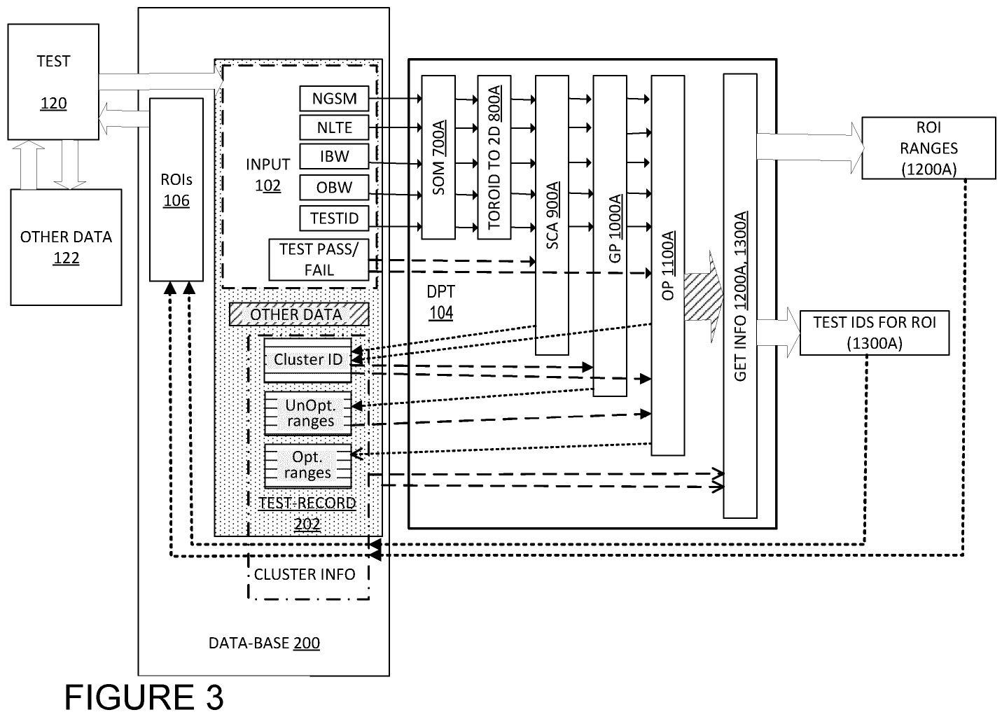

FIG. 3 illustrates schematically more details of an example embodiment of a test set-up for testing a configurable physical entity such as a transceiver device 110, which may be fully automatically in some embodiments, but which may, in other embodiments be implemented in a less-automated manner. The test set-up comprises a test 120, a data store shown as data-base 200 which stores test-cases, one or more other sources or stores of data 122 which are used by the test, and a data-pruning tool, DPT 104. DPT 104 performs a method 300 of determining one or more regions of interest in a multi-dimensional data set formed by the test cases stored in database 200. Method 300 reduces the amount of re-testing that may need to be performed to find a set of configurations of a physical entity according to any of the embodiments of the method 300 disclosed herein. Test 120 represents an measurement or assessment test which is conducted under a set of one or more test conditions on a configurable physical entity, where the configuration of the physical entity is maintained for a test run comprising a plurality of different test cases, each test case comprising a set of N different test conditions under which a particular test is conducted. In some embodiments, the test set-up is configured to automatically run and save test data as test-cases in the data-base 200. In some embodiments, the test set up is configured to retrieve a test case for configuring a set of N different test conditions for configuring a test from data-base 200. Test set-up 120 may also be configured to automatically use other data sources 122 to configure a test in some embodiments.

Some embodiments of the DPT 104 of FIG. 3 will be described in more detail below in the context of an example embodiment of test set-up 120 which comprises the transceiver test set-up 120 of FIG. 1. Each test case provides as input 102 to the DPD, N parameter values representing N test conditions. In the embodiment illustrated in FIG. 3, the test conditions represent settings of the transceiver 110, and N=4. The test conditions of input 102 are shown in FIG. 3 as NGSM, NLTE, IBW, and OBW. It will be apparent to anyone of ordinary skill in the art, that N, which represents the dimensionality of the test condition data, can take other values and represent other types of test conditions in other embodiments of a test set-up.

Other embodiments of DPT 104 for such other embodiments of test-conditions may be used, for example, in an embodiment of a test set-up as shown in FIGS. 2A, 2B, or 2C to facilitate testing (or assessing) another type of configurable physical entity. Such a test set-up may, for example, perform a plurality of tests or assessments to assess a measurable characteristic of a physical entity under various different tests conditions depending on the nature of the test and whether the physical entity comprises, for example, a configurable physical device or a chemically configurable material or substance.

Describing the test-set-up shown in FIG. 3 now in more detail, data-base 200 comprises a multi-dimensional data-set 100 of test cases 102 for the test set-up 120 and also other information which may be relevant to the test cases and/or which may be created by the DPD 104. In FIG. 3, an example database test record 202 is shown as a dotted background box. Each database test record 202 includes at least test case data comprising a set of parameters representing the N test conditions for the test case (N=4, and the test conditions are shown as NGSM, NLTE, IBW, and OBW in FIG. 3), a test case identifier, and a test result metric or test result category which form input data 102 for the DPT 104. Each test record also includes information generated by the DPT 104 which is stored in association with test-case ID, such as cluster information, and other data.

Examples of other data which a test record 202 may include comprise information about a current test and/or a history of the configuration of the physical entity which was tested under the test conditions of that test case. Each test case input 102 comprises a set of N test conditions for a test. If the test is repeated, for example, with a different configuration of the physical entity, the test-case is updated, and the previously tested configuration may be maintained in a test-history as other information associated with the test-case.

The cluster information which may be stored in association with a test-case ID includes at least a cluster identifier, ID, which identifies which cluster that test-case has been assigned to by the DPT 104. The cluster ID for each test-case is used by GP module 1000A and OP module 1100A of the DPT 104 which respectively generate an unoptimized range set comprising an unoptimized set of boundary values for each of the N dimensions of test conditions of the test cases which belong to that cluster identifier and an optimized range set comprising optimized range values found by OP module 1100A of DPT 104. Each test-case record 202 may also include other cluster information such as the maximum and minimum values of the weights for each dimension or test-condition of the cluster which are found by the GP module 1000A and OP module 1100A.

The cluster information comprising the cluster ID and the range of weights or test-conditions it is associated with is also used by the Get Info module which is configured to extract all of the test case identifiers in a cluster for a particular test result category and associate these with the ranges of the test conditions of that cluster to form a region of interest for retesting with a different configuration of the physical entity . In the case of the transceiver test, a region of interest compromises all test case identifiers for failed tests in a cluster.

In some example embodiments of the transceiver test-setup, test-case input 102 to the DPT 104 shown in FIG. 3 comprises the following data items which are made available to various modules of the DPT 104: a test id data item which identifies the test; a plurality of test parameter values for the N test conditions; a transceiver test result category: “Test pass/fail”.

SOM module 700A receives the test id and the test conditions which in this example embodiment comprises four radio settings for the transceiver to output a signal suitable for being carried over a number of LTE carrier networks (represented by a value n for an LTE parameter), a number of GSM carrier networks (represented in the test case by a number n of GSM carrier networks, the instantaneous bandwidth (IBW) (represented by a frequency value), the occupied bandwidth (OBW) (represented by another frequency value). For example, a test-case record 202 could input a set of values for nLTE=2, nGSM=0, IBW=600 MHz, OBW=540 MHz, as the test case data input 102 to the SOM module 700A of DPT 104. The SOM module 700A will map these values weights of neurons on its surface mesh and retains with each mapped neuron the test ID so that this can be used by SCA module 900A to form clusters of neurons which are predominantly or wholly associated with a particular test result category, for example, to cluster neurons representing test fails. Details of the operations that SOM module 700A, SCA module 900A (and the other modules of the DPT 104) perform are described later on.

In some embodiments, each record 202 associated with a test-case ID in the data base also comprises additional items of information, for example, a carrier type, power, and location—for example, LTE 700 MHz center at x MHz, LTE 4 MHz center at y MHZ. A log may be included to show how may DPD restarts have been made (i.e. new configurations of the DPD found for that test case), and other information such as crest, EVM enable, carrier modulation, and total power not included in the test case input 102 to the DPD 104.

Each record 202 also includes data items for each cluster ID for each cluster identified by the DPT 104 together with the maximum and minimum values for each of the radio settings for the test cases mapped to that cluster. For example, each range set of radio conditions of a cluster to which the test case was mapped may be indicated as: IBWmin<IBW<IBWmax, OBWmin<OBW<OBWmax, nGSMmin<=nGSM<=nGSMmax, nLTEmin<=nLTE<nLTEmax , for example, 550 MHz <IBW<650 MHz, 554 MHz<OBW<704 MHz, 0<=nGSM<=2, 0<=nLTE<3. Different range set values may be provided for the same cluster ID to represent the unoptimized ranges of values and the optimized ranges of values.

The transceiver test 120 in FIG. 3 represents a measurement test set-up for the various combinations of radio settings for the transceiver 110 which is used to test if a configuration of the transceiver created buy using a particular set of linearization parameters to configure the DPD 112 results in the transceiver output signal 118 passing a transceiver test or not. In some embodiments, the transceiver test 120 measures if the peak power spectrum output of the signal 118 matches or remains below a regulatory spectrum mask value in which case the test is passed, or if it exceeds the regulatory spectrum mask value, in which case the test is failed.

In some embodiments, test 120 is also configured to automatically reconfigure the transceiver by obtaining new sets of linearization parameters for automatically configuring the DPD 112 for retests from a data source such as another database 122 in FIG. 3. Other examples of data bases 122 include a data base of clipping rules, back-off data etc. as well as data base of software release data which can also be used to automatically configure the DPD 112 when running the test over a range of radio settings.

In some embodiments, the transceiver test result is represented pass or fail result category indicator as shown in FIG. 3 for input 102 which indicates if a peak power spectrum of the output signal 118 of the transceiver was measured to be respectively below or above a regulatory spectrum mask value for peak power spectrum output.

In some embodiments, instead or in addition, a test result value or other performance metric or value is used. One example of a different test result comprises a value indicating a relative strength of the peak power spectrum of the signal 118 compared to the value of the regulatory spectrum mask which may be also stored in a test case record 202 and/or provided to the DPT 104 so that test cases with results which share the same values can be classified into clusters using the SOM ML model. Another example comprises a test result which can be represented by a value +2 db indicating the test was failed and the peak power spectrum output of signal 118 was 2 db above the regulatory spectrum mask (a −2 db value test result in contrast would indicate the test was passed and that the peak power spectrum output was 2 db below the regulatory spectrum mask).

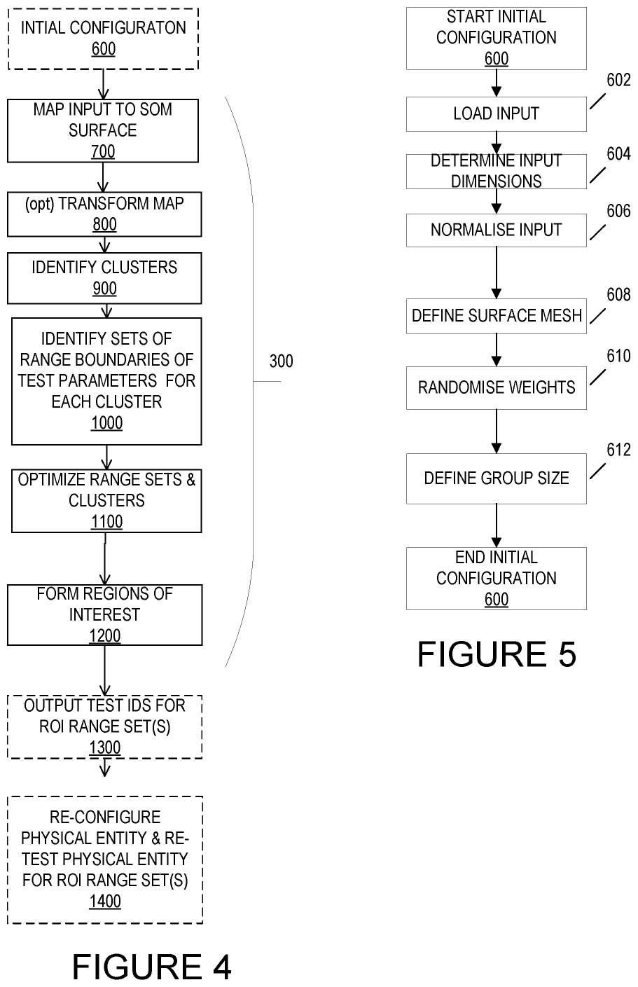

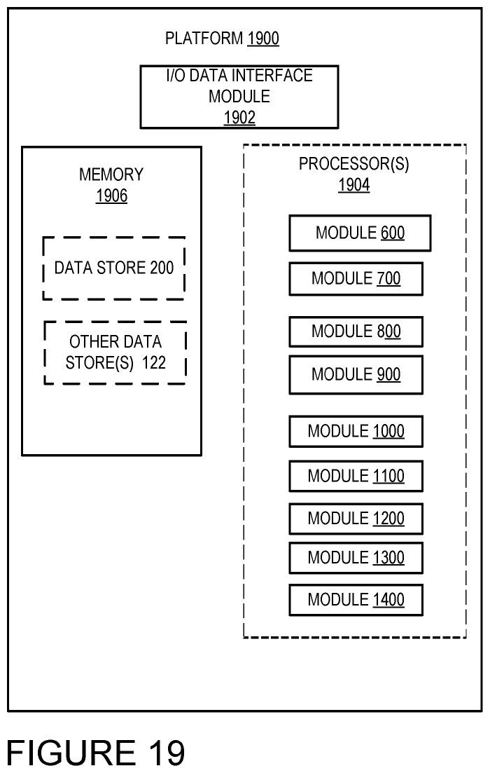

In FIG. 3, the modules of DPT 104 are labelled to correspond to process steps of a method 300 of determining regions of interest in a multi-dimensional data set shown in FIG. 4. In some embodiments of the DPT 104, the processes are performed in a different order to that shown in FIG. 3. The processes may be performed by suitable configured circuitry and/or software on a platform hosting the DPT 104, such as FIG. 19 shows. The platform may be a distributed or cloud-based platform.

The SOM module 700A performs a process which maps input to the DPT to a SOM surface (step 700 in FIG. 4). The Toroid to 2D module 800A performs a process which transforms the SOM map produced by step 700 from an edge-connected, toroidal, SOM mesh surface to a two-dimensional, 2D, planar surface (step 800 in FIG. 4). The SCA module 900A performs a process which identifies clusters of neurons on the SOM map (step 900 in FIG. 4). The GP module 1000A performs a process which determines a set of boundary ranges, also referred to herein as a range set, comprising a set of maximum and minimum values for each of the test conditions representing by weights of the neurons forming a cluster (step 1000 in FIG. 4). The OP module 1100A performs process 1100A which optimizes the test condition boundary ranges for each cluster and adapts the size and number of clusters so that the range set of each cluster minimally overlaps with the range set of another cluster (shown as process step 1100 in FIG. 4).

The Get Info module 1200A performs process step 1200 in FIG. 4 and may also perform process step 1300 of FIG. 4 in some embodiments. As shown in FIG. 3, the process 1200 associates the ranges of each ROI cluster, and associates this with the test-cases identifiers of the test cases in that cluster which failed to pass the transceiver test. The process 1200A determines the association between the maximum and minimum values of the test parameters for the test conditions of each ROI and the test-IDs for the test cases and stores the information for each region of interest in data base 200, so that the test-case conditions can be re-used in a test. In some embodiments, the Get Info module shown in FIG. 3 may also implement process 1300 which pushes the test-case IDs of the ROls as output for retesting. In other embodiments, the Get info module 1200 stores the ROI and test-case information for subsequent retrieval.

In some embodiments, information about one or more regions of interest, ROIs, 106 found by the DPT 104 are automatically accessed by the test set-up 120 so that the test-cases included in an ROI can be updated with re-test information, but in other embodiments, this information can be manually extracted from the database 200.

An embodiment of the DPT shown in FIG. 3 may be used in any of the example test-set ups and/or an assessment set-up or scenario illustrated in FIGS. 1 to 3 to implement the method steps shown in FIG. 4. The modules of the DPT shown in FIG. 3 may also be provided as a component of apparatus or processing circuitry to implement any of the other first to fourth method aspects disclosed herein.

FIG. 4 of the drawings shows schematically an example of a method which the processes of the modules of the DPT 104 in FIG. 3 may execute. In some embodiments of the method the method comprises computer-implemented method 300 of determining one or more regions of interest in a multi-dimensional data-set of test cases, for example where each test-case comprises n-dimensional test conditions for testing a configurable physical entity.

FIG. 4 also shows an initial configuration (step 600) which initializes the SOM ML model prior to the main method 300 starting. The SOM model initialization step 600 which needs to be performed only for the first iteration of the method 300 as the same configuration of the SOM ML model will be used for subsequent iterations.

Some embodiments of the computer-implemented method 300 for determining one or more regions of interest in a multi-dimensional data set can be used on a multi-dimensional data set which comprise a plurality of parameter sets, each parameter set comprising a parameter set identifier, N dimensions of selection conditions for a configurable physical entity, and an indication of a measured characteristic of the configurable physical entity. It will be appreciated that some of the steps shown for method 300 in FIG. 4 may be completed in a different order or omitted in some embodiments.

For example, one embodiment of method 300, which can be implemented using a suitable embodiment of DPT 104, for example, in the example set up of FIG. 2A, comprises: a method for determining one or more regions of interest 106 in a multi-dimensional data set comprising a plurality of parameter sets, each parameter set comprising a parameter set identifier, N dimensions of selection conditions for assessing a configurable physical entity 110, and an indication of an assessed characteristic 118 of the configurable physical entity 110, the method comprising: mapping (700), using a SOM model which uses competitive group learning, the multi-dimensional data set onto an edge-connected, for example, a toroidal or hypertoroidal, surface mesh of neurons; identifying (900) at least one cluster of neurons on the surface mesh based on a category of the assessed characteristic; identifying or determining (1000) a set of N ranges of boundary values for the N selection conditions for each cluster, each range of boundary values comprising a maximum and a minimum weight value of the weights representing that selection condition of the neurons in that cluster; and determining (1200) one or more regions of interest which associate the boundary values of the selection conditions of each cluster with one or more test case identifiers for the test cases represented by the neurons in that cluster.

In some embodiments of method 300, the number of different ranges comprising boundary values for each of the selection conditions is less than the total number of selection conditions, for example, if one of the selection conditions is not to be taken into account for the cluster analysis.

Another embodiment of the method 300 shown in FIG. 4, for example, where DPT 104 is used for a transceiver test set-up, such as, for example, that shown in FIG. 1 or FIG. 3, comprises: a method for determining one or more regions of interest in a multi-dimensional data set comprising a plurality of transceiver test cases, each transceiver test case comprising a test case identifier, plurality of radio settings for testing a configurable transceiver, and an indication of a test result of the transceiver test case for that plurality of radio settings. The method comprises: mapping (700), using a SOM model which uses competitive group learning, the multi-dimensional data set of test cases onto an edge-connected toroidal surface mesh of neurons; identifying (900) at least one cluster of neurons on the surface mesh based on the test result category of transceiver test; determining or identifying (1000) a set of ranges comprising boundary values for each radio setting for each cluster, each range of boundary values comprising a maximum and a minimum weight value of the weights representing that radio setting of the neurons in that cluster; and determining (1200) one or more regions of interest which associate each of the sets of radio setting boundary values of each cluster with one or more test case identifiers for the test cases represented by the neurons in that cluster which failed the transceiver test.

In some embodiments, the method comprises a computer-implemented method.

In some of the embodiments of the above embodiments of the method 300, the indication of a test result of the transceiver test comprises a test fail if the peak output power of the output signal of the transceiver exceeds a regulatory standard body spectrum mask for peak output power for one or more carrier networks. In some embodiments, the above method 300 further comprises resizing at least one cluster to have a size matching or exceeding a predefined ratio of test fails to test passes. The re-sizing may be performed by the SCA module 900A or the OP module 1100A shown in FIG. 3.

In some embodiments, using the SOM model in method 300, comprises: generating a representation of the parameter sets or the test cases of the multi-dimensional data set on an edge-connected, for example, a toroidal or hypertoroidal, SOM surface mesh comprising a plurality of neurons, each individual parameter set or test case being allocated to a selected neuron, wherein the self-organizing maps model comprises determining a center neuron of a collection of adjacent neurons as the selected neuron for an individual parameter set or test case when a collective correlation of the individual parameter set or test case with the collection of adjacent neurons has a value that is greater than any collective correlation of that individual parameter set or test case with all other possible collections of adjacent neurons.

In some embodiments of method 300, the method further comprises an optional transforming step (800) where the edge-connected surface mesh is transformed to a two-dimensional planar surface mesh prior to generating the regions of interest. This step may be omitted in some embodiments, or occur at another point that the point where it is indicated as being performed by the DPD 104 in FIG. 3 or by method 300 in FIG. 4.

In some embodiments of method 300, the identify cluster process step 900 and/or the optimize range sets and clusters process step 1100 comprises resizing at least one cluster to have a size matching or exceeding a predefined ratio of one category of the assessed characteristic to another category of the assessed characteristic.

In some embodiments of method 300, the method comprises resizing at least one cluster to minimize the number of overlapping dimensions of radio settings of that cluster with at least one other cluster.

In some embodiments of method 300, the optimize range sets and clusters process step 1100 comprises: resizing at least one cluster to minimize the number of overlapping dimensions of selection conditions of that cluster with at least one other cluster on the SOM surface mesh.

For example, OP module 1100A may resize a cluster by finding the closest neighbouring cluster on the SOM mesh and joining the two clusters together.

Yet another embodiment of method 300 shown in FIG. 4 comprises a computer-implemented method for determining regions of interest in a multi-dimensional input space, wherein the multi-dimensional input space represents a plurality of test cases for use with each of one or more radio settings of a transceiver device. The method 300 comprises the following steps, which do not need to follow the order given in all embodiments): analyzing the plurality of test cases using a self-organizing maps model to provide a representation (mapping step 700) of the test cases on a toroidal mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons; converting (step 800) the toroidal mesh representation into a two-dimensional representation; associating test results for each of the plurality of test cases with a respective neuron; identifying (step 900) one or more clusters of neurons within the two-dimensional representation based on the test results, and associating (step 1200) one or more regions of interest in the multi-dimensional input space with the one or more identified clusters of neurons within the two-dimensional representation.

In some embodiments, the radio settings are used to test the transceiver over a range of one or more of different frequency ranges, modulation types, and bandwidths.

FIG. 4 also shows an initial configuration process (step 600) which is performed by the DPT 104 in at least some embodiments of the method of FIG. 4, for example, to configure the modules 700A to 1300A of the DPT 104 shown in FIG. 3 or as described HEREIN. FIG. 4 also shows outputting (step 1300) the test ids for a region of interest, ROI. The test-ids output in step 1300 by method 300 are then used by a method of testing (1400) a configurable physical entity which the test-step 120 shown in FIG. 3 performs. In some embodiments, the step of outputting the test-ids (step 1300 in FIG. 4) is also performed by the get info module of the DPT 104 shown as implementing process modules 1200A and 1300A in FIG. 3.

In some embodiments, the test- set-up performs the method of testing 1400 by performing a test-run comprising a series of tests, each test using test conditions of a test-case which are extracted from the database 200 using the test-ids. This allows the same set of N test conditions to be used in a re-test with a new configuration of the physical entity.

This greatly reduces the amount of re-testing that needs to be done, as only the range of test conditions associated with a ROI need to be retested with the new configuration. Each test performed on the reconfigured physical entity can then be added to the data-set of test cases by updating the test-case data record 202 and the DPT 104 can be re-used if necessary to identify one or more regions of interest where the new configuration does not result in a test pass. In this manner, the DPT (104) can be used in a method of testing (shown as step 1400 in FIG. 4) which compromises to reconfiguring the physical entity and repeating the assessment using the selection conditions of each parameter set associated with a region of interest; updating each parameter set associated with a region of interest in the multi-dimensional data set with at least the result of the repeated assessment; and iteratively repeating method 300 using the same SOM model to find if there are any new regions of interest in the updated data set. In some embodiments, at least steps 700 to 1300 of method 300 are performed as a computer-implemented method, and one or more of the steps of reconfiguring the physical entity and updating each parameter set is controlled or performed manually. In some embodiments, the one or more of the steps of reconfiguring the physical entity and updating each parameter set are performed by a user manually controlling a computer.

In some embodiments of method 300, process sets 700 to 1200 are iteratively repeated using the same configuration of the SOM model after updating the multi-dimensional data set to include at least one updated or new test case found in a region of interest as the test-case was had a test fail result. Each updated test case record retains its test case identifier and the values for the N dimensions of radio settings used to test each configuration of the transceiver, the new test-result information, and information to indicate the current configuration and any configuration history information.

In some embodiments of method 300, the parameter sets comprise a test-case, the dimensions of selection conditions comprise dimensions of test conditions, and the indication of the measured characteristic comprises a test result of a test performed on the configurable physical entity under the test conditions. For example, in some embodiments of method 300, such as that which may be used by the DPD of FIG. 1 or 3 to find regions of interest in transceiver test case data, the configurable physical entity comprises a transceiver including a configurable DPD unit, the test conditions comprise radio settings for testing the transceiver, and the test comprises a transceiver test performed on the output signal of the transceiver. For example, the measurable characteristic comprises a fail test result category if the peak output power of the output signal of the transceiver exceeds a regulatory standard body spectrum mask for peak output power for one or more carrier networks. In some embodiments, the radio settings for testing the transceiver comprise the number or LTE carrier networks, the number of GSM carrier networks, the instantaneous bandwidth and the occupied bandwidth for the transceiver.

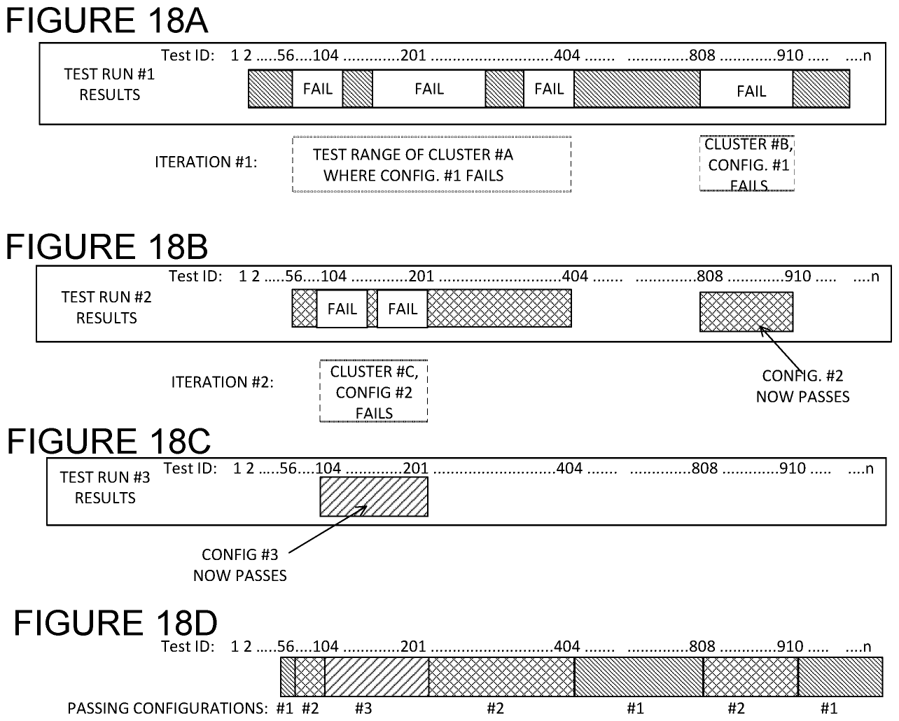

Using the DPT 104 enables a test set-up or system for implementing a series of tests such as test 120 of FIG. 3, to use fewer resources to find a set configurations to configure a physical entity so it can passing a test over a range of test conditions (see FIG. 18D for an illustration of this). Examples of the resources that use of the DPT 104 can save include, for example, time and energy as there is less use of the test equipment when it is used to retest new configurations of the physical entity. In some embodiments, the configurable physical entity is configurable using a configuration of settings, in which case the test 120 may be wholly automated. For example, transceiver test-set-up 120 may automatically reassign new linearization coefficients to a transceiver and re-test the transceiver over the range set of test conditions associated with the region of interest in which the test-case case was assigned.

In some embodiments, the configurable physical entity shown in FIG. 2A for example, may use an embodiment of the DPT 104 shown in FIG. 3 find one or more regions of interest in a multi-dimensional data set of parameter sets using a suitable embodiment of method 300, where the physical entity is one of: a configurable substance, such as a glass or concrete or other material; a configurable device; or a device including a configurable component.

In some embodiments, the configurable physical entity comprises a substance configurable to have various different ratios of chemical components or other constituent substances. The substance may comprises a glass, a material or a medicine such as a drug. In this manner, it is possible reduce the amount of retests performed on such substances to determine what chemical compositions of the substance will result in the substance passing a test over the range set of test conditions.

Advantageously, by suitably configuring the group size of SOM model 700 based on the number of test-cases provided as input 102 to the SOM ML model module 700A and the size of the surface mesh, the surface map of the SOM ML model becomes less random and more repeatable, allowing the same or similar clusters on the mesh surface as were generated in the previous iteration of the method 300 to be repeatedly found. This also results in the method of testing using fewer computational resources over a smaller amount of time, as it enables each region of interest where the new configuration of the physical entity has failed the test to be determined.

FIG. 5 shows in more detail an example embodiment of the initialization process 600 step of FIG. 4. In FIG. 5, the input 102 is loaded (step 602) and the input dimensions or number of features of the input represent an input vector of a SOM training data set is configured (in step 604). Other words, the input 102 from data set 100 forms the training data for the SOM ML model and the dimensionality of the input may be determined from user input or from the data itself in some example embodiments). Each neuron on the SOM mesh comprises four weight dimensions which are determined from each input vector. In the test-set up shown in FIG. 3, for example, four weight dimensions are determined as each input vector includes features which represent the test condition parameter values nGSM, nLTE, IBW, and OBW for each test case (each input vector will also include the test-id of the test-case it represents as well). This input data is then converted into a normalised data format (step 606) in each dimension.

The initialisation defines the surface mesh size (step 608) where the surface mesh is edge connected to form a hypertoroid so that this is suitably larger than the number of test-cases to be mapped to neurons on the mesh-points. For example, a mesh of 40×40 neurons may be formed. The weights of the neurons on the mesh-points are then randomised (step 610) to a normalised scale. As each input vector comprises n=4 dimensions, each neuron is randomly assigned four weights on a normalised scale. The adjacency or radius of the groups of neurons from a central neuron which defines the size of the group to used by the SOM model 700 for collective correlation depending on the way neurons are interconnected on the surface mesh is then defined (step 610). For example, a fully interconnected surface mesh of neurons such as that shown in FIG. 8A below with a radius of 1 will result in 9 neurons, of which 8 neurons surround and are adjacent to a single centre or king neuron. Those of ordinary skill in the art will appreciate that the radius is greater than 1 for the group SOM approach as if the radius is set to one the SOM model converts to a traditional SOM model with no group correlation as only a single best matching neuron is found by correlating its randomised weights with each input vector.

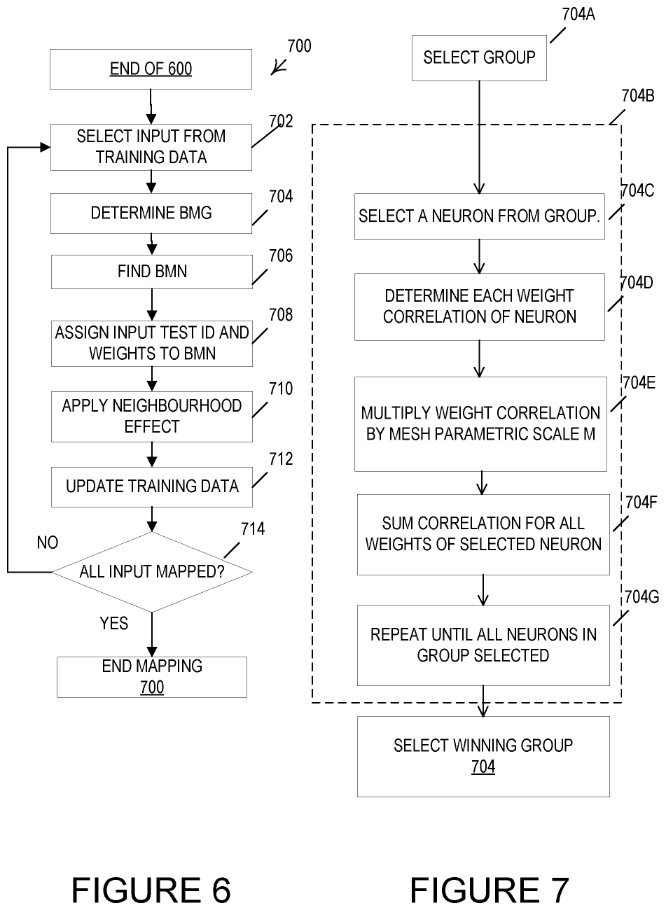

FIGS. 6 and 7 show the steps which the following example of pseudo code when executed form an example embodiment of an initialised SOM model implemented by an example embodiment of SOM module 700.

In FIG. 6 the SOM module 700 first selects (702) an input vector j (x₁, x₂, x₃, . . . , xₙ) where N is the dimension representing the number of different test parameter values for the test conditions from the input training data set 102 of input vectors. Two example mappings of two input vectors j₁, j₂ to neurons labelled 21 and 31 on an example 3×3 edge-connected mesh is shown in FIG. 8A of the drawings for the transceiver test set-up example embodiment shown in FIG. 3. In FIG. 3, and in FIG. 8A, n=4 as there are four different parameter values for the test conditions and each input vector j represents values for the IBW, the OBW, the nGSM, and the nLTE radio setting transceiver test conditions of a particular test case.

In FIG. 6, the SOM model maps each input vector to a neuron located on an edge-connected surface mesh, for example on a toroidal surface mesh by first determining a best matching group, BMG, of neurons (step 704). For example, by determining which group g of a plurality of possible groups G has the maximum group correlation to the input vector j, and so is the winning group. In some embodiments, each group G comprises nine neurons with an adjacency radius=1 from a central neuron when arranged on an m×m edge-connected SOM mesh. More detail of how step 704 find the BMG is shown in FIG. 7 described below.

An edge-connected surface mesh refers to a mesh in which each meshpoint has an equal number of adjacent neighboring mesh-points.

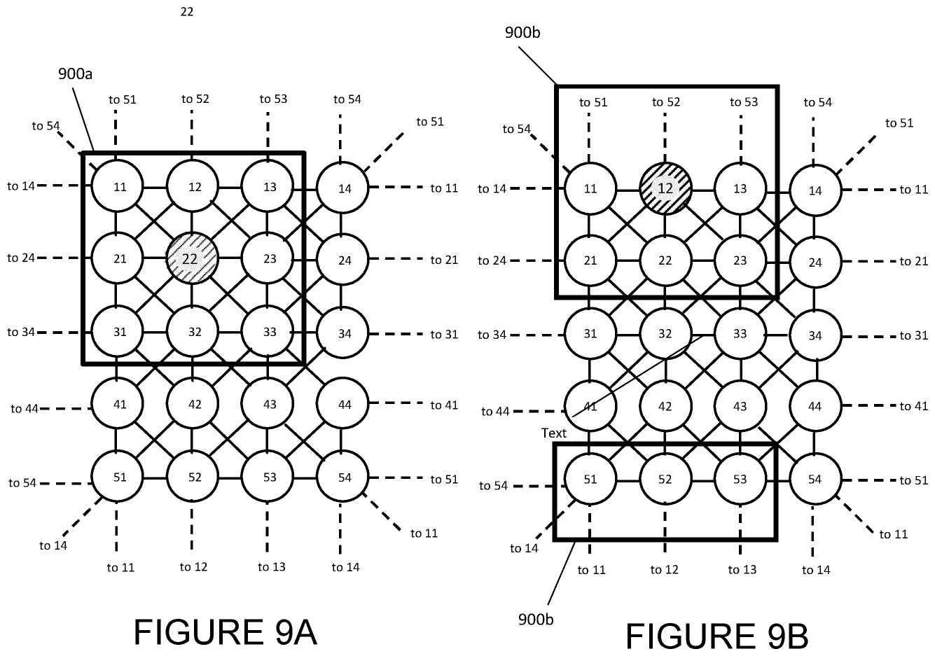

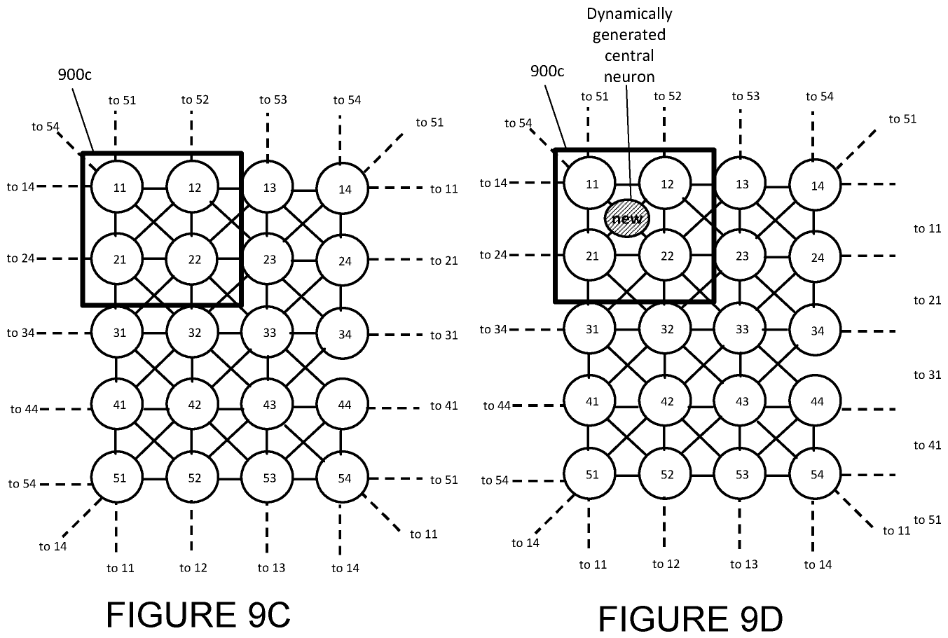

The best matching neuron, BMN, of the BMG is then determined (step 706) by finding the neuron of the BMG which has the maximum group correlation to the selected input vector and the test identifier. Depending on the group radius, there may or may not be a central neuron. FIGS. 9A and 9B (described more fully later on), illustrate schematically how a central neuron is the BMN on the surface of an edge-connected, for example, a toroidal or hypertoroidal, mesh of two example groups of neurons. If the initialized group size on a particular mesh configuration does not result in a single BMN, however if there is no central neuron in the BMG, a central neuron is dynamically created on the mesh in some embodiments of the SOM ML model (see, for example, FIG. 9D described more fully later on).

The test id and weights associated with the input vector are then assigned (step 708) to the BMN (the central neuron of the BMG, the winning group).

Next a neighborhood effect transformation is applied to apply a similar weight transformation to neurons in the neighborhood of the BMN (step 710). An example of a suitable neighborhood function is a neighborhood function determining how weights are decrementally adjusted as the neuron's distance from the BMN increases. For example, one suitable neighborhood function known in the art expresses the distance over which neighboring weights are updated using a Euclidean distance function:

Euclidian distance=\sqrt{Σₖ₌₀^{r type 2}(x−a)²}

where r type 2 is the radius of the update (to minimize the time of operation (as updates are minimal for greater distances), in which case each new weight of a neighboring function is determined by the old weight plus the magnitude (+/−) of the update to the BMN multiplied by the weight change to the BMN multiplied by a function, for example, by a Gaussian function of the Euclidian distance (e.g. e-beta*distance) where beta represents the sharpness of the Gaussian curve, which will affect how sharply the magnitude of the updates fall for neighboring neurons which are further away from the BMN.

Each input vector j is then removed from the training data set or suitably tagged or otherwise marked in the training data 102, so that it is not selected again as it has already been mapped to a neuron on the SOM mesh (step 712). After this, a check (step 714) is performed to determine if all the input vectors of the training data set 102 have been mapped and if not, the process returns to step 702 to select another input vector from the training data 102) until all the input vectors have been mapped and the SOM model training phase ends.

FIG. 7 shows in more detail how the SOM model selects the BMG (i.e. the winning group of neurons) from which a BMN (a winning or king neuron) for a given input vector j.

In FIG. 7, step 704 determines the winning group by first selecting (step 704A), for example, in a random or pseudo-random selection process) a group g of a plurality of groups G, where each group g of the plurality of groups G has an adjacent radius R and comprises n neurons positioned on the edge-connected m×m SOM mesh. Next, the group correlation to the input vectorj is determined (step 704B) which comprises first selecting (step 704C) a neuron N from the n=1 to 9 neurons forming that group of neurons. Then, for each weight w of the set of weights w₁, w₂, w₃, . . . wᵢ of the selected neuron N, the weight correlation with input vector j is determined (step 704D) and the weight correlation is then multiplied with a parametric scale m (step 704E). The correlation for all four weights w is then summed (step 704F). The group with the best correlation sum is selected as the winning group which completes step 704). For example, in some embodiments, step 704F can be expressed as comprising, for each weight W₁W₂ . . . Wₙ of the selected neuron i, of the plurality of N neurons in that group g which corresponds to a feature i of the selected input vector j, determining the weight correlation with the corresponding feature i of the input vector j and multiplying the determined weight correlation by a parametric scale aik of the 2D edge-connected mesh of neurons. This can also be expressed as finding the lowest group error (for the best group correlation):

$$group error = {\sum }_{i = 0}^{r type 1} {\sum }_{k = 0}^{dimensions} {a}_{ik} * abs ( {i}_{n} - {w}_{ik} )$$

where r type 1 here means the group radius from the central neuron (=1 in the example embodiment illustrated in FIGS. 9A and 9B for example, where the group size is 9 neurons). k represents the number of dimensions (for example, the nGSM, nLTE, OBW, IBW) of the input vector), aᵢₖ is a parametric scaling factor which affects the resolution of the chosen data on the surface mesh, and which may be different for different dimensions (in which case it acts also as a bias for individual input dimensions). n in the above equation represents the nth test case or nth input vector from the data set, and wᵢₖ represents the i^{th} neuron's weight for a particular dimension k).

An example embodiment to illustrate steps performed when initializing and mapping using the SOM module (steps 600 and 700 respectively in FIG. 4) follows, where parametric values may be defined by user input in some embodiments, for example, when initializing the SOM model:

### Pseudo Code Based Example

Define a parametric sized 2D mesh whose edges are connected(toroid), for example, a 40×40 (total 1600 neurons) mesh.

Randomize the weights on normalized scale; here for example, 4 weight values (because of input dimensions) for each 1600 neurons.

Define the adjacency radius greater than or equal to 1 for the training groups on the SOM mesh, for example an adjacency radius of 1 means 9 neurons with a center neuron as the best matching or king neuron. If the adjacency radius is zero, then there is no group stage, and a generic SOM mapping would be implemented.

The numbers below and in each of the following pseudocode examples are for illustrative worked examples only as will be apparent to any one of ordinary skill in the art. For each input test id (1 of 800 samples in the representational input space)
For each training group of neurons (9 of 600 possible groups of the 800 samples)
For each neuron (1 of 9) in a training group

For each weight of neuron (1 of 4, as there are N dimensions in this example)
Calculate weight correlation
Multiply weight correlation with parametric scale
Sum all the correlation for all for 4 weights

Sum correlation of each neuron of the army to determine the training group correlation.

Find max correlation for all training groups on the edged-connected mesh to determine the winning training group

Find best neuron of wining group (in this case this will always be the central neuron) and update the weights of that best neuron to those of the input vector representing that input test id

Assign the test ID number to that wining neuron (and exclude this neuron from the next iteration using the other test-ids)

Apply neighborhood effect on parametric sized radius r type 2 (see the neighborhood function example described above)

### End of Pseudo Code Based Example

FIG. 8A shows schematically an example of how an input vector j for the transceiver test case set-up of FIG. 3 where each input vector j comprises a set of four weights representing four values for the nLTE, nGSM, IBW, OBW radio settings of a transceiver test case are mapped using an embodiment of the SOM model 700 to a best matching (winning) neuron located on an example of an edge-connected surface mesh of the SOM ML model. In this example, for the sake of clarify the SOM mesh example comprises only 3×3 neurons, but in real embodiments, the mesh will normally be initialized to be a factor of three or more times the number of test-cases forming the input training data 102.

In the example of FIG. 8A, the WnLTE weight indicates a weight representing the number of LTE network carriers over which the output signal 118 of the transceiver 110 is to be carried. The WnGSM weight represents the number of GSM network carriers over which the output signal 118 of the transceiver 110 is to be carried. The WIBW weight represents the amount of instantaneous bandwidth used by the output signal 118. The WOBW weight represents the amount of occupied bandwidth occupied for use by the output signal 118. In the example shown in FIG. 8A, two test case input vectors j1 and j2 are mapped, j1 to a neuron labelled 21 and j2 to a neuron labelled 31 in the example of the connected edge SOM surface mesh. In this example, the surface mesh is edge-connected by connecting each of the neurons on the mesh to each adjacent neuron on the mesh. Thus, for example, each of the three neurons on the top row of the mesh which are labelled 11, 12, 13 in FIG. 8A, are connected to each adjacent neuron shown on the bottom row in FIG. 8A which are labelled as neurons 31, 32, and 33. Similarly each neuron 11, 21, 31 shown forming the left-most column on the edge-connected surface mesh in FIG. 8A is connected to each adjacent neuron, including those shown the far right column labelled neurons 13, 23, and 33.

FIG. 8B shows the edge-connected 3×3 SOM surface mesh of FIG. 8A after it has been transformed to an edge connected surface mesh by module 800 of the SOM system 400. It should be noted, however, that not all embodiments of the method of determining one or more regions of interest shown in FIG. 1 will transform the edge-connected surface mesh to an edge connected surface mesh directly after the initial mapping of the training data, and some may never perform a map transform. For example, a map transform may not be needed in embodiments where sufficient computational resources are available to handle the map representations on the edge-connected surface mesh. In some embodiments of the DPT 104 of the test set-ups where the computational resources are sufficiently powerful, the toroidal to 2D module 800 may accordingly be omitted from the DPT 104.

FIG. 8C shows an example of a structured map on the edge connected surface mesh for an example of the transceiver test of FIG. 3. The values shown represent those of the test result performance metrics for each of the test cases of the representational input space represented in the map, in other works the peak output power of the signal 118 of the transceiver 110.

FIG. 8D shows an example of how a map transformation from an edge connected, i.e. toroidal map of FIG. 8C to an edged map affects the clusters training data 102 on the map. Both maps are shown with example values which represent the peak power spectrum of the transceiver output signal 118. The values of the two-dimensional heat map of FIG. 8D is also represented by the three dimensional peaks shown in FIG. 8E.

The effect of the transformation on the structure of the neurons located on the surface mesh can be seen in FIGS. 8C and 8D as reducing the dimensionality of the solution space to one which can be represented by a heat map which preserves the structure of the performance metrics of the test cases in the representational input space. FIG. 8D illustrates how module 800 cuts the hypertoroid output of the SOM module 700 into a two dimensional form.

This reduces the number of computations required for the DPT to generate the regions of interest in the output data set and so results in a technical benefit as power is saved as fewer computational resources are required and also as the process of obtaining the output is sped up.

Each rectangular box in FIG. 8D represents a neuron which has been mapped to an input vector of the training data. Each mapped neuron comprises the following information: a test case identifier associated with that input vector, the test parameter values (e.g. the nLTE, nGSM, IBW, and OBW radio settings of the transceiver) and a value representing a pass/fail strength of that test which is also input to the DPT 104 from the training data. In this manner, the SOM is able to cluster test cases on the map based on the test parameter values and generate the map with an indication of the peak power spectrum output and/or an indication of the test result category (i.e. a pass/fail).

FIG. 8E shows schematically an example of how if the output signal 118 exceeds the communication standards regulatory spectrum mask value shown as a plane in FIG. 8E for peak power spectrum output, the transceiver test result is a fail, whereas if the peak power spectrum output does not exceeds the mask value, the transceiver test is passed. In this example, the pass-fail peaks of each test ID were measured against a boundary value of 10, and a pass for the transmission selection condition of the transceiver's output signal implies the peak signal strength was less than 10, and a fail implies the peak signal strength was higher than 10.

Those skilled in the art will appreciate that other tests may be used for testing the transceiver output and/or for testing other configurable physical entities, and that a test may comprises more than one test or selection condition .

FIG. 9A shows an example of a winning neuron on an example of an edge-connected surface of the SOM model and FIG. 9B shows another example of a winning neuron on an edge-connected surface of the SOM model of FIG. 9A. Both FIGS. 9A and 9B show schematically how an example edge connected surface mesh allows winning groups of neurons in the SOM model to be found where the number of neurons forming the surface mesh is fixed during the training phase (note, in some embodiments, the surfaced mesh may still grow dimensionally during the toroid to 2D conversion stage 800).

In FIG. 9A, a 5×4 SOM toroidal surface mesh example is shown in which the center neuron of a group of neurons of adjacent radius 1 is neuron 22. FIG. 9B shows the same 5×4 mesh where the center neuron of another illustrated group with the same adjacency radius of 1 is neuron 12.

FIG. 9C shows schematically an example of a winning training group with no single best matching neuron on an edge-connected surface of the SOM model. FIG. 9C shows schematically how a new single best matching neuron for the winning group of FIG. 9C is generated as the central neuron for the group on an edge-connected surface of the SOM model.

In some embodiments of the SOM such as that shown schematically in FIG. 9C and 9D, the size of the surface mesh is allowed to grow if a smaller group 900c of adjacent neurons such as neurons 11, 12, 21, and 22 in FIG. 9C can be identified as having the best collective weight correlation for a particular input vector but not contain a central neuron. As shown in FIG. 9C, in this situation, the best matching group size is four for a particular input vector but this does not contain a central neuron, and so one is dynamically created in a manner which preserves the mesh topology (not in FIG. 9D, the mesh topology has not been updated to accommodate the newly created central neuron). In this embodiment of a flexibly sized SOM surface mesh of neurons, the number of meshpoints grows with each dynamically created central neuron in any suitable manner known in the art for dynamically growing a SOM surface mesh whilst maintain its surface topology.

In some embodiments, the mesh size is dynamically adjusted to enable the data clusters to be sufficiently separated on the mesh surface. If the input test data is not well correlated, then there will be large numbers of smaller clusters on the mesh surface, and a larger mesh surface may be required. In some embodiments, the SCA algorithm implementing step 900 automatically adjusts the originally initialized mesh surface to increase the mesh surface (for example, to 3.5 or 4 times the number of input vectors which are to be mapped to the mesh) to ensure sufficient separation of the clusters.

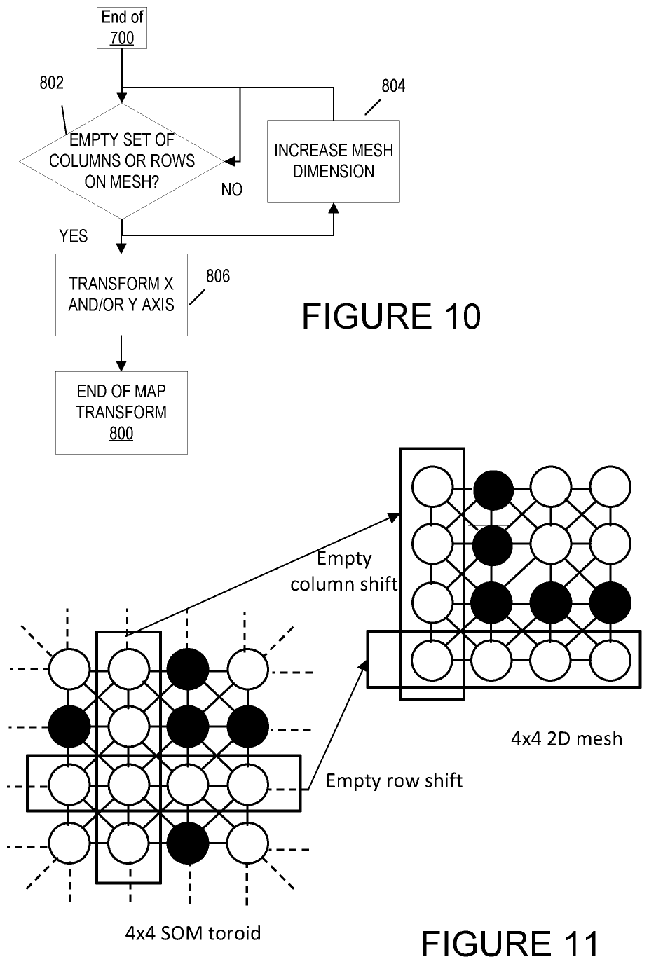

FIG. 10 shows an example embodiment of an optional process which can reduce the computational complexity required by the DPT 104. The map transformation which module 800A implements in FIG. 3 may occur directly after the training data has been mapped by the SOM ML model to the edge-connected, hypertoroidal SOM surface mesh in some embodiments, but in some other embodiments, may be implemented partially or wholly in another processing stage, for example, as part of the SCA module 1000 the hypertoroidal mesh size may be increased to facilitate distinct clusters, and after this the the hypertoroidal surface mesh to reduce the computational complexity of determining a range set of boundary values for each clusters weights.

In the example embodiment of the DPT 104 shown in FIG. 3, the map transform is performed by the Toroid to 2D module 800 directly after the training data 102 has been mapped to the edge-connected, hypertoroidal, surface mesh of the SOM ML model to transform the hypertoroidal surface mesh to a planar 2D surface mesh at the end of the SOM training phase 716.

In FIG. 10, the following steps are implemented by the algorithm of module 800. Firstly, determine (step 802) if any unoccupied mesh points form an entire empty row or column, if not, then the algorithm 800 may cause the mesh size to be increased (step 804) until it is possible to transform the hypertoroidal map into a 2D planar map where an x-axis is located on an empty row and the y axis is located on an empty column of a 2-D surface mesh (step 806) which completes the transformation process.

An example of a pseudo code based embodiment of the steps performed by the toroid to 2D module 800 follows.

### Pseudo Code Based Example

An example of pseudocode for implementing the steps which are performed by module 800 to transform the toroid surface to a 2D surface according to the method of FIG. 10 comprises:

Find empty space in x and y axis in the mesh (step 802). Else save the x axis ‘a’ value and y axis ‘b’ value.

Now shift the x axis data by a value and y axis data by b values.

If empty does not exist, then increase dimension by 20% and repeat the SOM apart again.

This results in a mesh which is ready to be treated as a 2D mesh.

Apply next set of algorithms which are good for 2D rather than toroid.

### End of Pseudo Code Based Example

FIG. 11 shows this transformation process schematically for a 4×4 SOM toroidal mesh which is transformed to a 4×4 2D mesh, where the dark circles represent mesh points on the SOM surface which are occupied by winning neurons (i.e. neurons which have been mapped to input vectors from the training data set) and where white circles occupy empty mesh points.

FIG. 12 illustrates schematically of a method 900 comprising process steps performed by an example embodiment of the SCA module 900A of a DPT 104, such as, for example, the DPT 104 of FIG. 3. The method 900A which may be performed by an example embodiment of a cluster identification or spatter combining module SCA 900 shown in FIG. 3 of the accompanying drawings after the toroidal surface mesh of the SOM has been transformed to a 2D planar surface mesh by module 800A but in some embodiments, the map transformation may be performed afterwards or not at all.

The example process illustrated in FIG. 12 shows selects (step 902) a neuron from the SOM surface mesh (which may be a hypertoroidal or planar mesh structure). The test result category of that neuron then checked (step 904). For example, for the DPT 104 of FIG. 3, check (904) determines if the transceiver test result was a pass or fail. If the test result indicates a pass, or if other test result metrics are used, if the test result is a right category of result for being classified with other neurons into a cluster, a neighborhood of that passing neurons is checked (step 906) using a suitable neighborhood function, which may be any type of neighborhood function that someone of ordinary skill in the art would recognize as suitable for locating neighboring neurons on the mesh surface. If the test result category is wrong, then new meshpoint(s) are checked for occupancy and a new neuron is selected if the mesh point is occupied and the process can be repeated to form a cluster including that neuron.

Any neurons complying with the test selection condition(s) found in the neighborhood are associated with the selected neuron in (step 908) to form a cluster. Each new cluster is assigned a cluster ID which is then stored in database 200 in association with the relevant test case records 202 for the test case training data 102 represented by each neuron in the cluster as the cluster grows.

After all meshpoints on the surface SOM have been checked, the neurons on the surface mesh will have been classified into clusters mostly or wholly associated with neurons representing test cases where the transceiver test was passed in the embodiment of the DPT 104 shown in FIG. 3.

FIG. 13 shows schematically an illustration of the result of the process performed by an example embodiment of the SCA module 900 of an example DPT 104. In this example, an example SOM surface mesh of 4×4 meshpoints is shown on which three distinct examples clusters A, B, and C of occupied neurons are shown as having been found by the SCA module 900.

A pseudocode example is now given for a mesh having 1600 meshpoints (for a 40×40 2D SOM surface mesh) where the training data set 192 comprise input vectors representing 800 transceiver test cases meaning some 800 surface mesh points will remain unoccupied. The example SCA module 900 for the transceiver test case first checks for occupied meshpoints and then checks to see if these are associated with test case IDs for the transceiver 110 which have passed the selection condition(s) for the output signal of the transceiver 310, 406.

The steps below reflect an illustrative example of possible pseudocode based steps for implementing optimizing boundary values, where parametric parameter values may be user defined.

### Pseudo Code Based Example

Apply SCA 900 to find out a cluster. This is defined as follows:

Check each of 1600 neuron. Find the first failing neuron.

Within a third type of parametric radius of this failing case, find the next failing neuron and add it to the cluster.

Boundary cases (parametric boundary setting) are treated as failing case unless they don't have any more neighboring failing case. This means boundary cases help to connect the failing spattered cases together.

Store all the cluster info.

The term parametric radius as used herein may refer to a radius which can be initialized by process 600 for example, or by user input.

### End of Pseudo Code Based Example

FIG. 14 shows schematically an example embodiment of process 1000 which identifies a set of ranges comprising the maximum and minimum boundary values for each test parameter value weight represented by each neuron in a cluster found on the surface map (which may be hypertoroidal or 2D). An example of this process is performed by module GP 1000A of the DPT 104 shown in FIG. 3. The module 1000A is shown in FIG. 3 as receiving cluster information including a cluster ID from the SCA module 900A.

In some embodiments, after SCA 900A has completed the cluster identification process (step 900 in FIG. 4), the GP module 1000A identifies for each cluster a range set comprising a set of boundaries for each of the N test dimensions, i.e. the N test parameter values for the neurons in that cluster. In other words, for the example transceiver test case embodiment of FIG. 3, a range set may comprises a minimum nLTE value and a maximum nLTE value, a minimum nGSM value and a maximum nGSM value, a minimum IBW value and a maximum IBW value, and a minimum OBW value and maximum OBW value.

One example embodiment of a process 900 which the GP module 900A implements comprises: selecting a cluster from the one of more initial clusters on the 2D SOM surface mesh (step 1002), determining the maximum and minimum values in each dimension i of the weights Wi of any neuron in the selected cluster (step 1004). The maximum and minimum weights for each test dimension of the cluster are then stored (step 1006) in database 200 as unoptimized range set values associated with the cluster ID. The process then checks (step 1008) for other clusters on the SOM map and if any after found steps 1002,10004,1006 are repeated until in step 1008 no unselected clusters remain and the algorithm performed by GP module 1000A terminates.

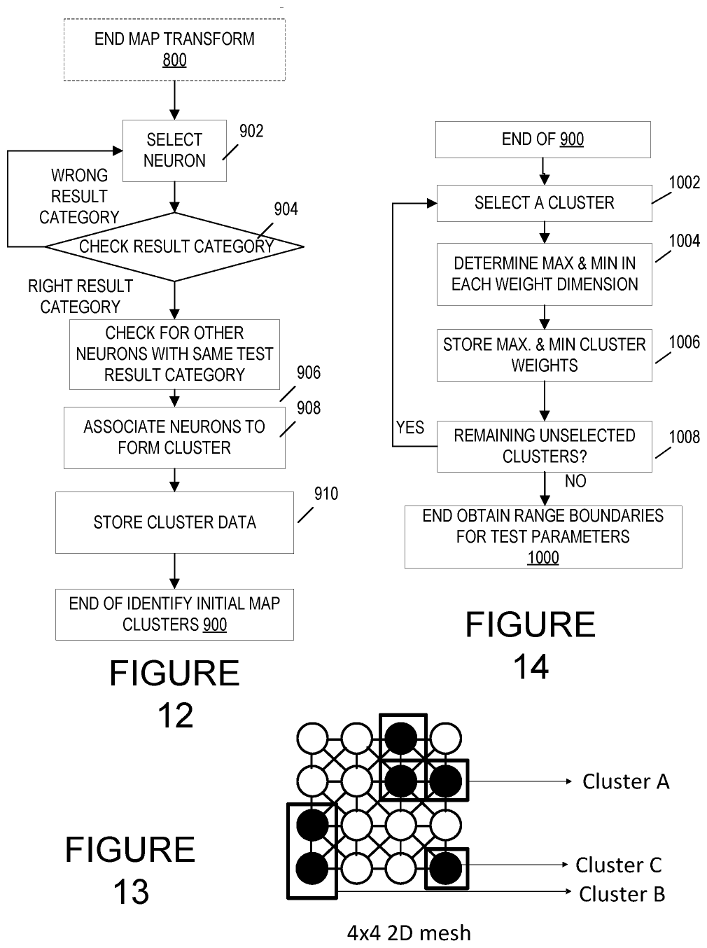

FIG. 15 shows schematically an illustration of the results of an embodiment of the process performed by GP module 1000A for the transceiver test set up embodiment in an example where the SCA module 900A found clusters #A, #B, and #C on the SOM mesh surface.

In this example, cluster #A section 1 is shown schematically as comprising four surface mesh points, three of which are occupied with neurons whose weights collectively fall with a range of IBW values from a minimum value MIN_{IBW1} to a maximum value MAX_{IBW1} value, and within the range of OBW values from a minimum value MIN_{OBW1} to a maximum value MAX_{OBW1} value, and within the range of a number of GSM carriers, nGSM, ranging from a minimum number of carriers MIN_{nGSM1} to a maximum number MAX_{NGSM1}, and within the range of a number of LTE carriers, nLTE, ranging from a minimum number of carriers MIN_{nLTE1} to a maximum number MAX_{NLTE1}. In this example, the black neurons represent test cases having a test result category comprising the test was failed, as the SOM is being used to find clusters of test cases which failed the test for certain test conditions.

In FIG. 15, the white neurons may represent test cases which passed the test (and so failed the cluster selection conditions) or which are empty meshpoints. In FIG. 15, cluster #A includes three neurons representing test cases where the transceiver failed to pass the transceiver test vs fail test and one where the test was passed. Cluster C includes two test cases which failed the test, and cluster C just one.

The output of GP module 1000A is then processed by the OP module components 1100A of the example DPT 104 of FIG. 3 which implements an optimize range sets and clusters process (step 1100) in FIG. 4. The OP module optimizes both the range sets and may also reconfigure the number and size of clusters to better delineate the range sets between clusters of failing test cases.

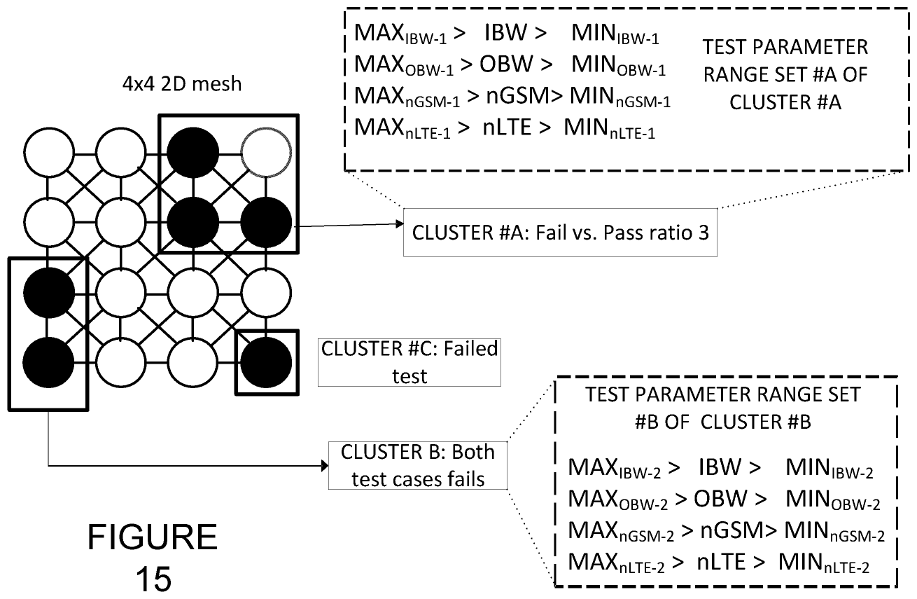

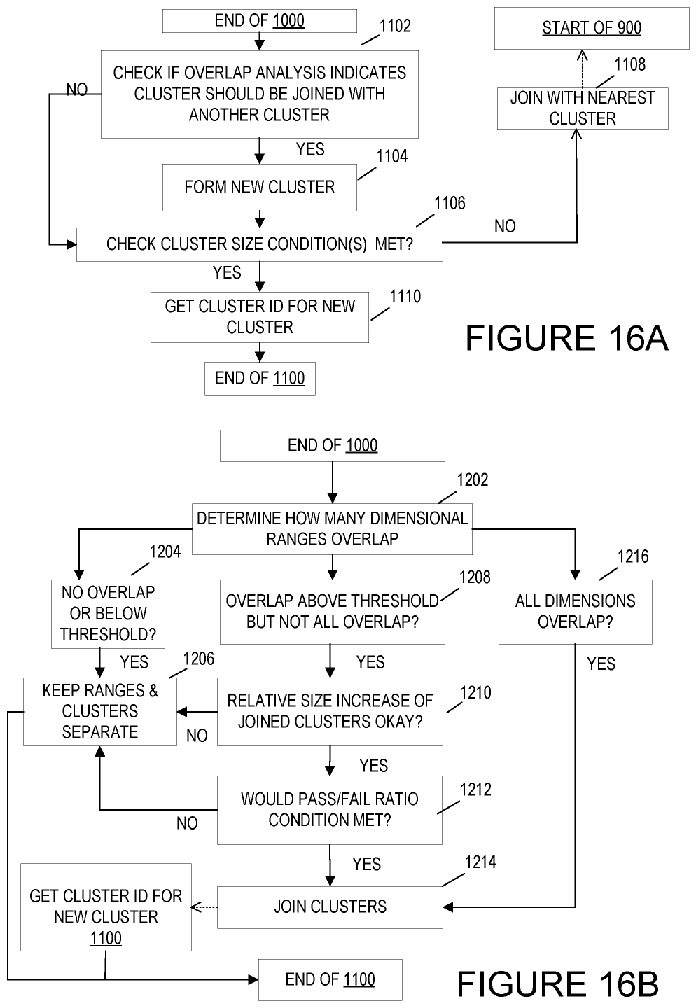

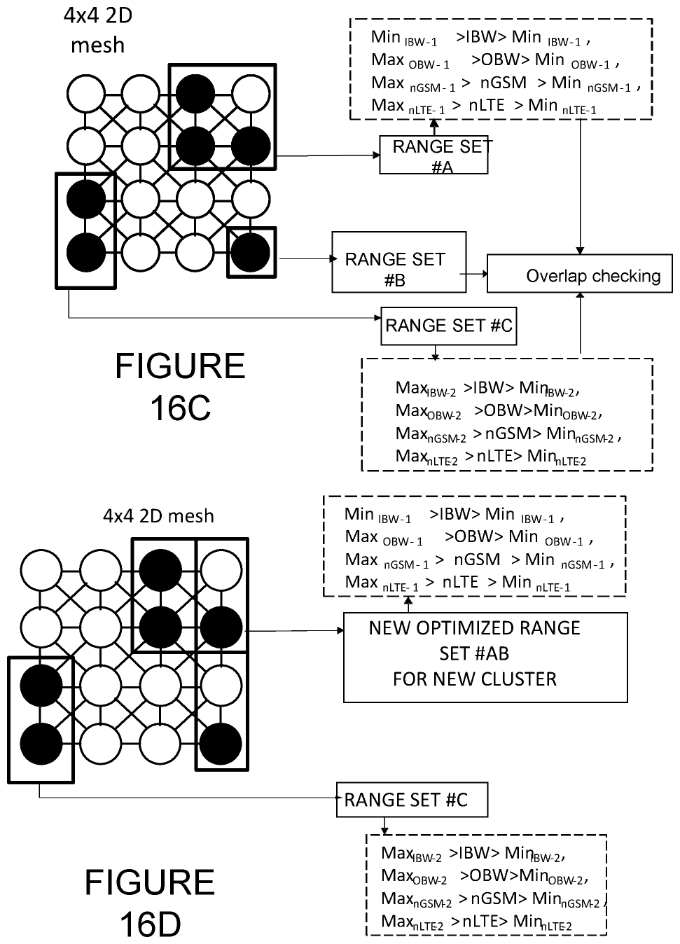

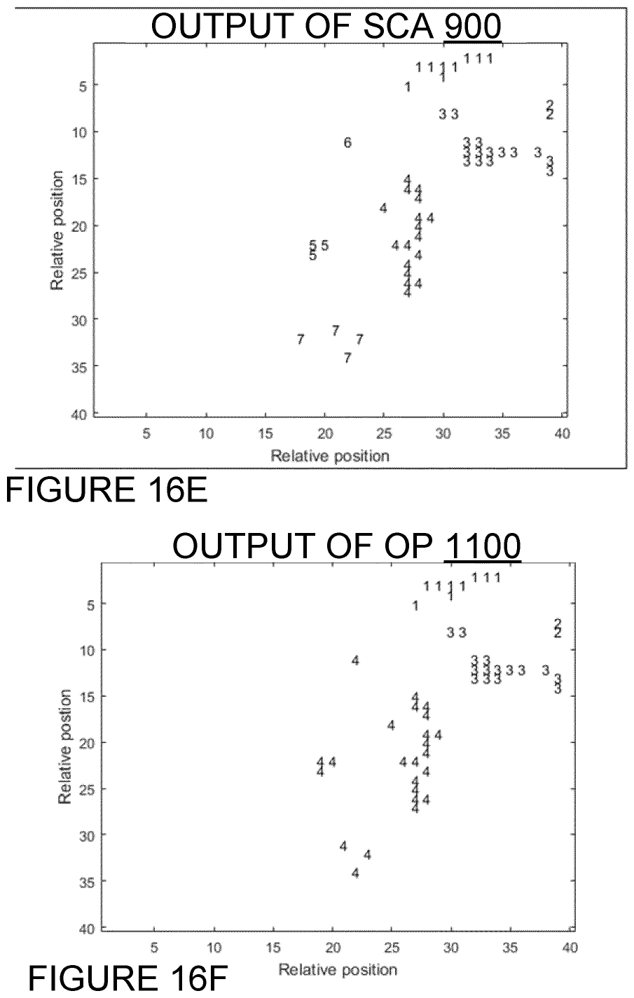

FIG. 16A shows an example embodiment of an overlap method 1100 which OP module performs. In FIG. 16A, the method comprises, for each cluster for the ranges of weights in each of the N test dimensions, determining (step 1102) if there is an overlap with the maximum and minimum ranges of weights in the same dimension N of another cluster in the SOM. If a sufficiently overlapping cluster range is found in determination step 1102, then the two sections are joined to form a new cluster (step 1104) and an additional analysis is performed which checks (step 1106) the size of the cluster against any cluster size conditions. If no overlapping section is found in step 1102, the fine analysis step starts directly with the cluster size check (step 1106).

In one embodiment, the cluster size check (step 1106) checks if the number of neurons in a cluster exceeds a predetermined minimum number with the test result category for the cluster formation, and if not, the cluster size is increased, for example, as shown in FIG. 16A, by returning to the start of the SCA cluster identification 900 or by another process. Alternatively, or in addition, in some embodiments, another cluster size condition for a ration of neurons associated with test fails to exceed the number with test passes in the example embodiment where the test is the transceiver test. If any cluster does not meet the size condition check performed in step 1106, one or more or all of the steps of SCA 900 can be repeated to increase that cluster's size until it can be joined to a neighboring cluster, and the subsequent process steps and the earlier overlap analysis steps are then repeated until the cluster size meets the minimum size conditions.

FIG. 16B illustrates in more detail an example embodiment of process 1100 where the overlap analysis of step 1102 is broken down to show how the number of test dimensions which overlap may affect whether two sections are joined or not.

In FIG. 16B, for each cluster found by process 900 and after that cluster's weight ranges have been found by process 1000, the ranges of each of the N different weights representing the N dimensions of test value parameters is individually checked to determine if there is an overlap with the maximum and minimum ranges of weights in the same test dimension of another cluster.

The example method shown in FIG. 16B comprises determining (step 1202) how many of the input dimensions have overlapping ranges. The method proceeds based on whether all of the number of dimensions of the input vector overlap (in which case the sections are automatically joined (step 1216), or whether, for example, a minimum number of dimensions overlap (step 1208) in which case, the method continues to check first in step 1210 if joining the cluster to a neighbouring cluster would result in a sufficient size increase, and if so, whether test result category criteria for the new cluster would be met (step 1212). If two clusters overlap sufficiently, would have a sufficiently larger size, and include a sufficiently high number of test results in the desired test category for cluster formation and/or a sufficiently high ratio of test results in the desired test result category to any other test result category, the two clusters are joined (step 1214) and a new cluster ID is assigned and the new cluster weight ranges can be determined, for example, by reverting back to the start of process 1000. If in step 1202 no overlap is found, or the overlap is insufficient to join the clusters, for example, perhaps there is an overlap in a test-dimension that is less important for retesting purposes, the clusters are kept separate (step 1206).

In the example embodiment of the transceiver test embodiment of FIG. 3, an example of a test result category criteria comprises a ratio of failed test cases to pass test cases being sufficiently high in step 1212.

In some embodiments, the level of sufficient cluster range overlap may be set by determining a minimum number of test dimensions N which must have a range overlap, for example, n>=2 and in some a specific proportion of the test dimensions is it set as an overlap condition for joining two clusters. For example, if there were 10 test dimensions, then if 50% or more (i.e. 5 or more dimensions) overlapped, the clusters would be joined, if 10% or less overlapped (i.e. if n=0 or 1) the clusters would not be joined, and if n=2, 3, or 4, joining the two clusters could be conditional on further checks on size and the test result category ratios both being passed.

In some embodiments, the cluster size increase check may be omitted and/or one or more other condition for overlapping sections to be joined applied instead.

FIGS. 16C and 16D show schematically the effect of the overlap process on an example 4×4 SOM mesh in the example embodiment where the transceiver characteristics represented by each input vector for a test ID comprise nGSM, nLTE, IBW and OBW. FIGS. 16C and 16D shows schematically how the clusters #A, #B, and #C shown in FIG. 15 are re-sized by the overlap analysis process and size checking process 1100 schematically shown in FIG. 16C so that clusters #A and #B are now joined to form new cluster #AB in FIG. 16D.

FIG. 16E illustrates schematically an example where seven optimised clusters have been formed where each number on the SOM mesh represents a cluster ID. FIG. 16F illustrates schematically an example where the seven optimised clusters with different sets of boundary values shown in FIG. 16E have been reduced to just four clusters.

### Pseudocode Based Example for Optimizing Boundary Values

The steps below reflect an example of possible pseudocode for implementing optimizing boundary values, where parametric parameter values can be user-defined in some embodiments.

### a) Overlap Analysis

Now for each cluster

Find if all four optimized boundary values overlap with another.

If all four joins, then join the clusters. But If only three-dimension (75%) predicates overlaps
1) then check if the clusters are joined, what is the new size of the cluster. Is the new size <=1.5 times old sizes added together of individual clusters (here the 1.5 times is parametric, i.e., it can be user-defined).
2) Is the fail/pass test ID ratio good (as in does it meet the ratio condition applied in the cluster selection analysis described above) for the new cluster with the new set of ranges? For example, does the fail/pass ratio of the test results go less than 10% (where the 10% is also parametric, as in user definable)?

If 1) and 2) conditions are met, then the clusters joined else the clusters are not joined.

If the range overlap is less than a minimum number, for example, 75%, of the N dimensions (in other words, for the exemplified embodiment where n=4, if less than 3 of the ranges overlap), then do not join the overlapping boundaries. (Here the 75% is also parametric and may be user defined in some embodiments.)

End of overlap analysis.

### b) Fine Analysis

Check if any range of a test dimension is too small. i.e. number of failing tests <=2) and (failing number of tests +range of boundary values of the test dimension <5) (where 2 and 5 are example values only and are parametric in the sense a user can configure them).

If the range between boundary values of a test dimension is too small, then find the nearest neighbour cluster having a range of boundary values for that test dimension by increasing the range of the boundary values for all test dimensions by 10%, for example, and repeating “a) overlap analysis” steps again. The ranges may be iteratively increased in steps of 10%, for example, until the increases reaches a cut-off, for example, 50% and fails the overlap analysis. Here the size of the incremental steps can be configured by a user as can the size of the cut-off. If no nearest neighbouring cluster can still be found at the 50% cut-off. This can be saved or printed at this point to record this information. Further increase the dimensions until the nearest neighbour is found.

### End of Pseudocode Example for Optimizing Boundary Values

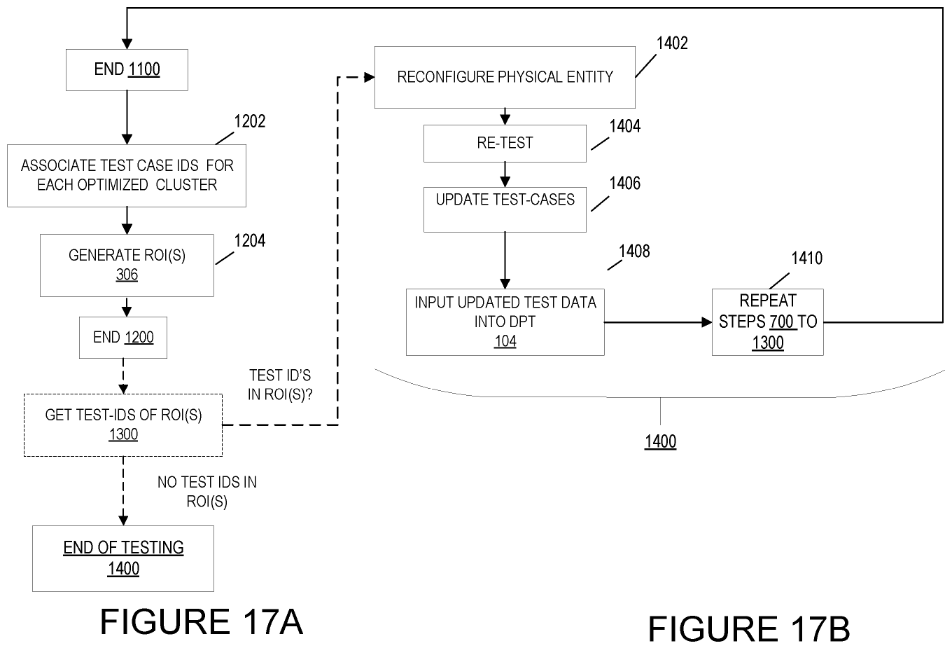

FIGS. 17A and 17B illustrate schematically an example of a method of testing (1400) which comprises performing method 300 repeatedly until no additional ROI are determined and the method of testing ends.

FIG. 17A (on the left hand side) shows schematically an example embodiment of a method 1200 which is performed by the Get Info module 1200A of a DPT 104 to generate regions of interest for subsequent tests. The example embodiment of method 1200 shown in FIG. 17A comprises extracting the test IDs of a particular category of test results for each optimized cluster (step 1202) and generating (step 1202) one or more regions of interest which associate the range set of optimized boundary values of the N test dimensions of each optimized cluster on the SOM surface mesh with the test-ids of that cluster.

In some embodiments where the test 120 is a transceiver test, an ROI comprises a set of test-ids where the tested DPD configuration of the transceiver 110 failed the transceiver test, i.e., the transceiver output signal 118 with a peak power spectrum which exceed a standards regulatory spectrum mask for the radio settings of the transceiver being tested. If no ROIs are found by the Get Info module 1200A , then that configuration of the DPD 112 of the transceiver 110 passed the test under all of the radio settings which were tested and the testing can end (step 1400). If one or more ROIs are found, however, then another run of tests needs to be performed to find a configuration of the DPD which results in the transceiver passing the test.

FIG. 17B (on the right hand side) shows schematically the method of testing 1400 comprises a first reconfiguring the previously tested configurable physical entity 110, such as, for example, a configurable transceiver 110 of FIG. 1. A precursor to this is step 1300 of FIG. 17A, which provides the test set-up with access to the relevant test-cases which were failed by the configurable physical entity in the previous test run.

In some embodiments, method of testing 1400 is performed by the test set-up 120 shown in FIG. 1, 2A to 2C and 3 and described herein, which also performs the step of extracting (step 1300) the test-ids in any ROI found by the previous iteration of method 300 performed by DPT 104. Alternatively, or in addition, step (1300) is performed by Get Info module 1200A of the DPT 104 saving the test-ids in the data-base 200 for subsequent retrieval by the test set-up when performing the method of testing (1400).

The example embodiment of a method of testing 1400 shown in FIG. 17B uses DPT 104 to implement an embodiment of method (300) of determining regions of interest as disclosed herein to reduce the amount of resources used in the testing process both to find the failed test cases and to determine the ranges of each test conditions where the test was failed.

In some embodiments method of testing 1400 comprises performing the method (300) and further performing: reconfiguring (1402) the transceiver and repeating (step 1404) the test using the radio settings of each test case associated with a region of interest; updating (1406) each test case associated with a region of interest in the multi-dimensional data set with at least the result of the repeated test; and iteratively repeating steps 700 to 1300 of method 300 using the same SOM model in DPT 104 to find if there are any new regions of interest in the updated data set input into the DPT (step 1408).

The embodiment method of testing (1400) shown in FIG. 17B comprises first reconfiguring (step 1402) the previous configuration of the physical entity for the new test run, which may be performed automatically or manually. By way of example, when the method of testing is testing a transceiver 110, step 1402 comprises selecting a different set of linearization parameters from other data store 122 (shown in FIG. 3) to configure the digital pre-distortion, DPD, unit 112 of the transceiver 110. This may be automated in some test set-ups. Next a new test run is conducted by performing tests (step 1404) on the new DPD configuration of transceiver 110 using all of the test cases with conditions (i.e. radio settings) in the ROI found in step 1300 and the method of testing 1400 then updates (1406) each test case record 202 in database 200 (as shown in FIG. 3) with the new test's test result.

In some embodiments, the test cases for the retests are automatically updated and once the test-run is completed, the updated data set 100 is input into the DPT 104 to find if there are any new ROls (step 1408), and steps 700 to 1200 of the method (300) of determining one or more regions of interest is repeated, and the test ids for any new ROls are obtained (step 1300) If output from the DPT 104 does not include any new ROI, the test has been passed with the new configuration over the ranges represented by the previous ROI (and the step ends). If the DPT finds new ROIs, the process repeats, until no ROI are found.

In some embodiments, the method of testing (1400) tests a transceiver having a configurable digital pre-distortion DPD unit, the method comprising: performing a method for determining one or more regions of interest in a multi-dimensional data set of test cases using a group learning SOM model to determine at least one region of interest comprising a set of boundary values of a plurality of radio settings for testing the transceiver where a first configuration of the DPD results in the transceiver failing a transceiver peak power spectrum output test; reconfiguring the DPD with a different set of linearization parameters; retesting the transceiver with the reconfigured DPD; updating the multi-dimensional data set with test cases for each retest of the transceiver; and repeating the method using the same SOM model configuration to determine one or more regions where the new configuration of the DPD results in the transceiver failing the transceiver peak power spectrum output.

In some embodiments, the SOM model provides a representation of the test cases on a toroidal mesh comprising a plurality of neurons, each individual test case being allocated to a selected neuron, wherein the SOM model determines a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons. The radio settings are used to test the transceiver are over a range of one or more of different frequency ranges, modulation types, and bandwidths, for example, to form a run of tests on a particular configuration of the transceiver. In some examples, the method is a computer-implemented method, for example, changing the configuration of the DPD using different linearization parameters is automated using a computerized test-set up in some embodiments of the method of testing.

FIGS. 18A to D illustrate schematically a simple example representation of how the data pruning tool can determine a set of three different configurations, #1, #2, #3 for a physical entity 110 to take in a set of sub-ranges of one dimension of test conditions to result in a test pass. As shown in FIG. 18A, in a first test run performed on the physical entity with configuration #1, a series of N test cases are performed over a range of test conditions where one of the N test parameter values for a test condition changes. For example, the test may be performed by varying the IBW or another one of the radio setting values of the transceiver in FIG. 3.

In FIG. 18A, the DPT 104 finds two regions of interest in a first iteration of method 1300, shown as clusters #A and #B, where test cases fail to pass the test.

The physical entity is then reconfigured, for example, to have configuration #2 and retested in a second test run as shown schematically in FIG. 18B. For example, in the case where a transceiver is being tested, a different set of linearization parameters are used for the DPD of the transceiver in the second test run. The second test repeats the test with the same radio settings of each individual test case, but only over the range of radio conditions where the first configuration of the transceiver failed to pass the transceiver test.

As shown in the example embodiment of FIG. 18C, configuration #2 led to the test being passed for the radio conditions tested using the test case IDs in cluster #B, but two ROls remain in cluster #A. A new configuration #3 of the transceiver is used in test run #3, and this resulted in further test fails, and so no more ROls would be found by the Get Info module 1200A of the DPT 104. FIG. 18D shows schematically how in this example, a configuration set comprises three different configurations, #1, #2, #3 can be adopted by a physical entity such a the transceiver in various sub-ranges of the test conditions, so that the transceiver can pass the test over the entire tested range of test conditions.

For example, if the test is a configurable transceiver test where the first test was conducted over a range of IBW values from 425 MHz to 575 MHz, if test IDs from 56 to 404 are associated with ROI cluster #A which has a range of IBW values from 450 MHz to 475 MHz, and test case IDs from 808 to 910 are associated with ROI cluster #B which has a range of IBW values from 500 MHz to 550 MHz, then the test needs to only be repeated using the 2^{nd} configuration of the transceiver for IBW values in the range 450 to 475 and 500 to 550 MHz. The result is that three configurations must be used by the transceiver if output signal 118 is to pass the transceiver test for the peak power spectrum output to not exceed a standards regulatory mask over the entire tested range of IBW (for example).

FIG. 19 shows an example embodiment of an apparatus according to any of the fifth, sixth, or eighth apparatus embodiments configured to implement an embodiment of any one of the first to fourth disclosed method aspect.

The embodiment of the apparatus illustrated in FIG. 19 comprises a platform 1900. In some embodiments, platform 1900 is configured to implement an example embodiment of the DPT 104. In some embodiments, the platform 1900 is configured to implement an example embodiment of the DPT 104, and to perform a test run comprising multiple test 120, which may use data from one or more other data stores 122, and which saves test cases including test case identifiers, the test conditions, and the test result in data store 200 (see also FIG. 3).

The embodiment of the platform 1900 of FIG. 19 comprises a plurality of components or modules, which may be implemented in hardware (i.e. using processing circuitry) or by a combination of hardware and software. In FIG. 19, the platform 1900 comprises an I/O data interface module 1902 configure to allow the platform to receive and output data, for example, to receive user interface input for initializing the DPT modules or data from one or more data stores 122 if these are not implemented using internal memory module 1906. Also shown as part of platform 1900 are one or more processor modules 1904. The processor module(s) 1904 may be configured in hardware and use circuitry for implementing one or more processing steps and/or use software instead or in addition to any hardware to execute computer instructions for implementing one or or all of the modules 600, 700 to 1300, and 1400 in some embodiments. One or more of the processor modules 1904 may be dedicated to providing the above modules of the DPT 104 in some embodiments where other processes or algorithms are performed by other processors 1906 of the apparatus.

In some embodiments, the platform 1900 comprises one or more of the modules 600 to 1400 illustrated in FIG. 19, where each of the modules 700 to 1300 provided is individually configured to perform one or more corresponding steps in a method 300 of determining one or more regions of interest according to any of the embodiments described herein, and in addition comprises a module for performing an initialization step 600 and/or a method of testing (1400) which uses the method 300.

In the illustrated embodiment of FIG. 19, memory 1906 comprises a data store or database of records, where the collection of records are the results of one or more test or assessment runs which generate a plurality of test cases or parameter sets for the configurable physical entity or object being tested/assessed. In some embodiments, memory module 1906 instead may locally cache one or more of the above example data sets of test cases or parameter sets if these are to be stored remotely (for example, in a distributed example of platform 1900, where the data base of test cases 200 is remote from the test-set up and DPT 104) so these can be readily accessed for processing by the modules 6000 to 1300 which implement the DPT 104 and/or the module 1400 for implementing a method of testing (for example, such as the method of testing test-set up arrangement shown in FIG. 3 which is also shown in FIGS. 17A and 17B).

In some embodiments, the platform comprises means functionally configured to implement any of the disclosed method aspects and embodiments.

In some embodiments, the apparatus comprises memory, at least one processor, and computer code stored in the memory which, when executed by the at least one processor, causes the apparatus to perform the steps of any one of disclosed method aspects and embodiments.

In some embodiments, the SOM ML model arrangement finds regions of interest in a multi-dimensional input space of test case data by reducing the n-dimensional test conditions under which a test is performed to a two dimensional representation of the n-dimensional test conditions on a SOM surface map.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware.

Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

In some embodiments of the data pruning tool 104 and/or of the method (300) of determining regions of interest in a representative multi-dimensional input space, the DPT 104 implements method 300 using a computer readable medium which may be stored in memory 1906 and/or executed by one or more processors 1904 of platform 1900. The computer readable medium has stored thereon a computer program comprising program instructions for implementing the method. The computer program is loadable into a data processor such as processor 1904 shown in FIG. 19 of the drawings. When loaded into the data processor 1904, the computer program may be stored in a memory (MEM) 1906 associated with or comprised in the data processor 1904.

In some embodiments, the computer program may, when loaded into and run by the data processing unit 1904, cause execution of method steps according to, for example, FIG. 4 or one or more of any of the process steps of FIG. 4 otherwise described herein.

In some embodiments, the machine executable computer-program product, comprises computer code which, when executed on an apparatus such as data platform 1900, causes the apparatus to perform the steps of any one of the disclosed method aspects of embodiments.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step follows or precedes another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

In some embodiments, the method steps of any of the disclosed methods are implemented in an apparatus comprising the arrangement depicted in FIG. 19.

In some embodiments of the platform 1900 shown in the FIG. 19 as a schematic block diagram, the platform 1900 comprises one or more or a combination of any of the disclosed independent apparatus embodiments. Some of the apparatus embodiments forming platform 1900 comprise processing circuitry 1904 and a memory 1906. The apparatus 1900, or the processing circuitry 1904, may also comprise the input/output module 1902, which may include a user interface module or circuitry and may be connected to a display and input means, or a display such as touch sensitive display which enables user input to be detected to provide the user defined parametric values used by the DPT 104 and any other processes disclosed herein. The I/O module 1902 may also comprise circuitry capable of receiving and transmitting information to other components in a distributed embodiment of platform 1900. This may allow remote configuration of a test-set up in some embodiments. The receiving and/or transmitting may use a wireless communications network and may form part of a single transceiver in some embodiments. It should also be noted that some or all of the functionality described in the embodiments above as being performed by the platform 1900 may be provided by the processing circuitry 1904 executing instructions stored on a computer-readable medium, such as, e.g. the memory 1906 shown in FIG. 19.

Some embodiments of the platform 1900 comprise an apparatus or processing circuitry configured to determine one or more regions of interest in a multi-dimensional data set comprising a plurality of parameter sets, each parameter set comprising a parameter set identifier, a plurality of dimensions of selection conditions for assessing a configurable physical entity, and an indication of an assessed characteristic of the configurable physical entity.

In some embodiments, the apparatus or processing circuitry is configured to or comprises: a mapping module for mapping, using a SOM model which uses competitive group learning, the multi-dimensional data set onto an edge-connected surface mesh of neurons; an identifying module for identifying at least one cluster of neurons on the surface mesh based on a category of the assessed characteristic; another identifying or determining module for identifying or determining a set of ranges of boundary values for the selection conditions for each cluster, each range of boundary values comprising a maximum and a minimum weight value of the weights representing that selection condition of the neurons in that cluster; and a module for determining one or more regions of interest which associate the boundary values of the selection conditions of each cluster with one or more test case identifiers for the test cases represented by the neurons in that cluster.

Some embodiments of the platform 1900 comprise an apparatus or processing circuitry configured to determine one or more regions of interest in a multi-dimensional data set comprising a plurality of transceiver test cases, each transceiver test case comprising a test case identifier, plurality of radio settings for testing a configurable transceiver, and an indication of a test result of the transceiver test case for that plurality of radio settings.

In some embodiments, the apparatus or processing circuitry is configured to or comprises: a mapping module configured to map, using a SOM model which uses competitive group learning, the multi-dimensional data set of test cases onto an edge-connected toroidal surface mesh of neurons; an identifying or determining module configured to identify or determine at least one cluster of neurons on the surface mesh based on the test result category of transceiver test; an identifying or determining module configured to identify or determine a set of ranges comprising boundary values for each radio setting for each cluster, each range of boundary values comprising a maximum and a minimum weight value of the weights representing that radio setting of the neurons in that cluster; and an identifying or determining module configured to identify or determine one or more regions of interest which associate each of the sets of radio setting boundary values of each cluster with one or more test case identifiers for the test cases represented by the neurons in that cluster which failed the transceiver test.

Some embodiments of the platform 1900 comprise an apparatus or processing circuitry configured to determine regions of interest in a multi-dimensional input space, wherein the multi-dimensional input space represents a plurality of test cases for use with each of one or more radio settings of a transceiver device.

In some embodiments, the apparatus or processing circuitry method is configured to or comprises one or modules configured to perform: analyzing the plurality of test cases using a self-organizing maps model to provide a representation of the test cases on a toroidal mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons; converting the toroidal mesh representation into a two-dimensional representation, associating test results for each of the plurality of test cases with the respective neuron, identifying one or more clusters of neurons within the two-dimensional representation based on the test results, and associating one or more regions of interest in the multi-dimensional input space with the one or more identified clusters of neurons within the two-dimensional representation.

Some embodiments of the platform 1900 comprise an apparatus or processing circuitry configured to test a transceiver having configurable digital pre-distortion DPD.

In some embodiments, the apparatus or processing circuitry is configured to or comprises apparatus or circuity configured to or comprising a set of modules configured to determine one or more regions of interest in a multi-dimensional data set of test cases using a group learning SOM model using an embodiment of any of the disclosed method embodiments, for example, a method according to any of the first to fourth embodiments. Is some embodiments, the apparatus or circuitry is further configured to determine at least one region of interest comprising a set of boundary values of a plurality of radio settings for testing the transceiver where a first configuration of the DPD results in the transceiver failing a transceiver peak power spectrum output test. In some embodiments, the apparatus or processing circuitry is configured to or further comprises a reconfiguring module configured to reconfigure the DPD with a different set of linearization parameters, a (re)testing module configured to (re)test the transceiver with the reconfigured DPD using radio settings of each test-case in the at least one region of interest; and an updating module configured to update the multi-dimensional data set of test cases with at least a new test result for each retested test case

In some embodiments of the apparatus or processing circuitry, the apparatus or processing circuitry is further configured to or comprises a mapping module using a SOM model to generate a representation of the test cases of the multi-dimensional data set on an edge-connected SOM surface mesh comprising a plurality of neurons, each individual test case being allocated to a selected neuron, wherein using the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons.

In some embodiments of the apparatus and/or processing circuity, a SOM model configuration is used repeatedly in each iteration which determines if there are one or more regions of interest where a new configuration of the DPD results in the transceiver failing the transceiver peak power spectrum output test.

In some embodiments of the apparatus or processing circuitry, the apparatus or processing circuitry is further configured to or comprises a transforming module for transforming the edge-connected surface mesh to a two-dimensional planar surface mesh prior to generating the regions of interest. For example, a toroidal or hypertoroidal mesh can be transformed into an edged planar surface mesh to reduce the computational complexity associated with using a continuous surface mesh. The transformation can take place at any point where it is advantageous to reduce the computational complexity. In some embodiments, one or both of the identifying or determining modules comprise a modular component for resizing at least one cluster to have a size matching or exceeding a predefined ratio of one category of the assessed characteristic to another category of the assessed characteristic. In some embodiments of the apparatus or processing circuitry, the module for identifying or determining a set of ranges of boundary values further comprises a modular component for resizing at least one cluster to minimize the number of overlapping dimensions of selection conditions of that cluster with at least one other cluster on the SOM surface mesh.

In some embodiments of the apparatus or processing circuitry, the apparatus or processing circuitry is further configured to or comprises a test-set apparatus, for example, a test set up component or module, arranged to allow reconfiguring of the physical entity. In some embodiments of the apparatus or processing circuitry, the apparatus or processing circuitry is further configured to or comprises a test-set component or module arrange to allow the assessment to be repeated using the selection conditions of each parameter set associated with a region of interest; updating each parameter set associated with a region of interest in the multi-dimensional data set with at least the result of the repeated assessment; and iteratively repeating the steps of the above first method aspect using the same SOM model to find if there are any new regions of interest in the updated data set.

In some embodiments of the apparatus or processing circuitry, the apparatus or processing circuitry is further configured to or comprises the reconfiguring module being configured to enable one or more of the steps of reconfiguring the physical entity and updating each parameter set to be controlled or performed manually. In some embodiments of the apparatus or processing circuitry, the apparatus or processing circuitry is further configured to or comprises a set of modules which collectively implement the steps of an embodiment of any of the first to fourth method aspects as a computer-implemented method. In some embodiments, the parameter sets comprise a test-case, the plurality of dimensions of selection conditions comprise a plurality of dimensions of test conditions, and the indication of the assessed characteristic comprises a test result of a test performed on the configurable physical entity under the plurality of test conditions.

In some embodiments, the configurable physical entity comprises a transceiver including a configurable DPD unit, the plurality of test conditions comprise radio settings for testing the transceiver, and the test comprises a transceiver test performed on the output signal of the transceiver. In some embodiments, the assessed characteristic comprises a fail test result category if the peak output power of the output signal of the transceiver exceeds a regulatory standard body spectrum mask for peak output power for one or more carrier networks. In some embodiments, the radio settings for testing the transceiver comprise the number or LTE carrier networks, the number of GSM carrier networks, the instantaneous bandwidth and the occupied bandwidth for the signal output by the transceiver. In some embodiments, the configurable physical entity is one of: a configurable substance, such as a glass substance; a configurable device; or a device including a configurable component, such as, for example, a transceiver 110 with a configurable DPD 112 component or unit.

Some embodiments of the apparatus or processing circuitry, comprise modules configured to perform the steps of any one of the disclosed embodiments of the first, second, third or fourth method aspects.

Some embodiments of the apparatus or processing circuitry comprise a memory module, at least one processor module, and computer code stored in the memory module which, when executed by the at least one processor module or processing circuitry, causes the apparatus or processing circuitry to perform the steps of any one of the disclosed embodiments of the first, second, third or fourth method aspects.

In some embodiments, a machine executable computer-program product comprises computer code which, when executed on the apparatus or processing circuitry, causes the apparatus or processing circuitry to perform the steps in any one of the disclosed embodiments of the first, second, third or fourth method aspects.

In some embodiments a computer program, comprising instructions which, when executed in any of the processing circuitry or apparatus embodiments disclosed as being configured or operated using computer program or computer code, cause the apparatus or processing circuitry to carry out any of the disclosed methods of determining regions of interest in a data set or at least part or all any of the method of testing aspects. In some embodiments, the computer program comprises the computer code of any of the embodiments of the fifth, sixth, or seventh aspects described above as including computer code. Some of the examples of the disclosed data pruning tool 104 are implemented using such a computer program and apparatus 1900 or processing circuitry 1906 for executing the computer program. In some embodiments, the computer program code is structured so that the processing circuitry is configured to or the apparatus 1900 comprises at least the modules 700 to 1300 of the DPT 104. In some embodiments, the computer program code is structured so that the processing circuitry 1906 is further configured to or the apparatus 1900 further comprises the initialization module 600 and an user interface module or component to enable user input to the initialization module 600. In some embodiments, the computer program code is structured so that the processing circuitry 1906 is further configured to or the apparatus 1900 further comprises a module for implementing at least the automated steps of the method of testing module 1400. In some embodiments, all of the method of testing module 1400 comprises automated steps. Another aspect of the disclosed technology comprises a carrier containing the computer program aspect, wherein the carrier is one of an electronic signal, optical signal, radio signal, or computer-readable storage medium.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

As disclosed herein, several examples have been provide where a configurable physical entity such as a device or substance having a range of possible attribute ranges has been exemplified by reference to a configurable transceiver 110 comprising a configurable digital pre-distortion, DPD, unit 114. Another example of a configurable physical entity comprises another type of device, for example, an electrical device or component, such as, for example, a motor.

In one example, a configurable material or substance comprises a glass material or other substance composed of a range of chemicals, each chemical being able to form a different percentage weight (% wt) of the glass. In some embodiments of this example, a SOM ML model of the DPT 104 is used to reduce a multi-dimensional parameter input space comprising the ranges of ratios (which may be expressed as percentage weights) that various known glass component chemicals (attributes) of the glass substance are suitable for a certain type of use of the glass. By determining which composition of glass (i.e. what component chemicals/chemical compounds and their relative ratios) are associated with certain manufacturing techniques (for example, what types of glass could be formed using a float glass manufacturing method, a non-floating glass manufacturing method, or some other manufacturing method), the glass may be classified for a particular category of use.

Advantageously, some embodiments of the disclosed technology use less resources than would be the case if—all possible combinations of characteristics within the large data set were tested as only combinations of characteristics from a region of interest within the large data set may need to be tested. If a selected combination of characteristics from a region of interest results in the physical entity failing the test, then the data pruning tool, DPT, 104 can be iteratively used as disclosed to drill down into that region of interest to find smaller regions of interest within that region of interest from which a new combination of characteristics of the physical entity can be tested. This allows more rapid convergence on combinations of characteristics that result in the physical entity having a characteristic which passes the test.

1.-34. (canceled)

35. A computer-implemented method for determining one or more regions of interest in a multi-dimensional data set comprising a plurality of parameter sets, each parameter set comprising a parameter set identifier, a plurality of dimensions of selection conditions for assessing a configurable physical entity, and an indication of an assessed characteristic of the configurable physical entity, the method comprising:
mapping, using a self-organising map (SOM) model which uses competitive group learning, the multi-dimensional data set onto an edge-connected surface mesh of neurons;
identifying at least one cluster of neurons on the surface mesh based on a category of the assessed characteristic;
identifying a set of ranges of boundary values for the selection conditions for each cluster, each range of boundary values comprising a maximum and a minimum weight value of the weights representing that selection condition of the neurons in that cluster; and
determining one or more regions of interest which associate the boundary values of the selection conditions of each cluster with one or more test case identifiers for the test cases represented by the neurons in that cluster.

36. The method of claim 35, wherein using the SOM model comprises:
generating a representation of the parameter sets of the multi-dimensional data set on an edge-connected SOM surface mesh comprising a plurality of neurons, each individual parameter set being allocated to a selected neuron, wherein using the self-organizing maps model comprises determining a center neuron of a collection of adjacent neurons as the selected neuron for an individual parameter set when a collective correlation of the individual parameter set with the collection of adjacent neurons has a value that is greater than any collective correlation of the individual parameter set with all other possible collections of adjacent neurons.

37. The method of claim 35, further comprising transforming the edge-connected surface mesh to a two-dimensional planar surface mesh prior to generating the regions of interest.

38. The method of claim 35, further comprising resizing at least one cluster to have a size matching or exceeding a predefined ratio of one category of the assessed characteristic to another category of the assessed characteristic.

39. The method of claim 35, further comprising resizing at least one cluster to minimize the number of overlapping dimensions of selection conditions of that cluster with at least one other cluster on the SOM surface mesh.

40. The method of claim 35, further comprising:
reconfiguring the physical entity and repeating the assessment using the selection conditions of each parameter set associated with a region of interest;
updating each parameter set associated with a region of interest in the multi-dimensional data set with at least the result of the repeated assessment; and
iteratively repeating said mapping, said identifying of at least one cluster of neurons, said identifying of a set of ranges of boundary values, and said determining using the same SOM model to find if there are any new regions of interest in the updated data set.

41. The method of claim 35, wherein the parameter sets comprise a test-case, the dimensions of selection conditions comprise dimensions of test conditions, and the indication of the assessed characteristic comprises a test result of a test performed on the configurable physical entity under the test conditions.

42. The method of claim 41, wherein the configurable physical entity comprises a transceiver including a configurable digital pre-distortion (DPD) unit, the test conditions comprise radio settings for testing the transceiver, and the test comprises a transceiver test performed on the output signal of the transceiver.

43. The method of claim 42, wherein the assessed characteristic comprises a fail test result category if the peak output power of the output signal of the transceiver exceeds a regulatory standard body spectrum mask for peak output power for one or more carrier networks.

44. The method of claim 42, wherein the radio settings for testing the transceiver comprise the number or LTE carrier networks, the number of GSM carrier networks, the instantaneous bandwidth and the occupied bandwidth for the signal output by the transceiver.

45. The method of claim 35, wherein the configurable physical entity is one of:
a configurable substance;
a configurable device; or
a device including a configurable component.

46. A computer-implemented method for determining one or more regions of interest in a multi-dimensional data set comprising a plurality of transceiver test cases, each transceiver test case comprising a test case identifier, a plurality of radio settings for testing a configurable transceiver, and an indication of a test result of the transceiver test case for that plurality of radio settings, the method comprising:
mapping, using a self-organising map (SOM) model which uses competitive group learning, the multi-dimensional data set of test cases onto an edge-connected toroidal surface mesh of neurons;
identifying at least one cluster of neurons on the surface mesh based on the test result category of transceiver test;
determining a set of ranges comprising boundary values for each radio setting for each cluster, each range of boundary values comprising a maximum and a minimum weight value of the weights representing that radio setting of the neurons in that cluster; and
determining one or more regions of interest which associate each of the sets of radio setting boundary values of each cluster with one or more test case identifiers for the test cases represented by the neurons in that cluster which failed the transceiver test.

47. The method of claim 46, wherein using the SOM model comprises:
generating an representation of the test cases of the multi-dimensional data set on an edge-connected SOM surface mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons.

48. The method of claim 46, wherein the method further comprises transforming the edge-connected surface mesh to a two-dimensional planar edged surface mesh prior to the step of identifying at least one cluster.

49. The method of claim 46, wherein the indication of a test result of the transceiver test comprises a test fail if the peak output power of the output signal of the transceiver exceeds a regulatory standard body spectrum mask for peak output power for one or more carrier networks.

50. The method of claim 46, further comprising:
resizing at least one cluster to have a size matching or exceeding a predefined ratio of test fails to test passes, wherein the indication of a test result of the transceiver test comprises a test fail if the peak output power of the output signal of the transceiver exceeds a regulatory standard body spectrum mask for peak output power for one or more carrier networks; or
resizing at least one cluster to minimize the number of overlapping dimensions of radio settings of that cluster with at least one other cluster.

51. The method of claim 46, further comprising:
reconfiguring the transceiver and repeating the test using the radio settings of each test case associated with a region of interest;
updating each test case associated with a region of interest in the multi-dimensional data set with at least the result of the repeated test; and
iteratively repeating said mapping, said identifying, said determining of a set of ranges, and said determining of one or more regions of interest using the same SOM model to find if there are any new regions of interest in the updated data set.

52. A computer-implemented method for determining regions of interest in a multi-dimensional input space, wherein the multi-dimensional input space represents a plurality of test cases for use with each of one or more radio settings of a transceiver device, the method comprising:
analyzing the plurality of test cases using a self-organizing maps model to provide a representation of the test cases on a toroidal mesh comprising a plurality of neurons, each individual test case being allocated to a selected neuron, wherein the self-organizing maps model comprises determining a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons;
converting the toroidal mesh representation into a two-dimensional representation;
associating test results for each of the plurality of test cases with the respective neuron;
identifying one or more clusters of neurons within the two-dimensional representation based on the test results; and
associating one or more regions of interest in the multi-dimensional input space with the one or more identified clusters of neurons within the two-dimensional representation

53. A method of testing a transceiver having configurable digital pre-distortion (DPD), the method comprising:
determining one or more regions of interest in a multi-dimensional data set of test cases using a group learning, self-organising map (SOM) model to determine at least one region of interest comprising a set of boundary values of a plurality of radio settings for testing the transceiver where a first configuration of the DPD results in the transceiver failing a transceiver peak power spectrum output test;
reconfiguring the DPD with a different set of linearization parameters;
retesting the transceiver with the reconfigured DPD using radio settings of each test case in the at least one region of interest;
updating the multi-dimensional data set of test cases with at least a new test result for each retested test case; and
and repeating said determining using the same SOM model configuration to determine if there are one or more regions where a new configuration of the DPD results in the transceiver failing the transceiver peak power spectrum output test.

54. The method of claim 53, wherein the SOM model provides a representation of the test cases on a toroidal mesh comprising a plurality of neurons, each individual test case being allocated to a selected neuron, wherein the SOM model determines a center neuron of a collection of adjacent neurons as the selected neuron for an individual test case when a collective correlation of the individual test case with the collection of adjacent neurons has a value that is greater than any collective correlation of the individual test case with all other possible collections of adjacent neurons.
